(19) United States
(12) Patent Application Publication
(10) Pub. No.: US 2015/0356446 A1
(43) Pub. Date: Dec. 10, 2015

(54) SYSTEMS AND METHODS FOR A LEARNING DECISION SYSTEM WITH A GRAPHICAL SEARCH INTERFACE

(71) Applicant: LF Technology Development Corporation Limited, London (GB)

(72) Inventors: Alexander Greystoke, Lakeway, TX (US); Daniel Senyard, Austin, TX (US)

(73) Assignee: LF Technology Development Corporation Limited, London (GB)

(21) Appl. No.: 14/738,881

(22) Filed: Jun. 13, 2015

Related U.S. Application Data
(63) Continuation-in-part of application No. 14/169,058, filed on Jan. 30, 2014.
Application No. 14/169,058 is a continuation-in-part of application No. 14/169,060, filed on Jan. 30, 2014.
Application No. 14/169,060 is a continuation-in-part of application No. 14/640,865, filed on Mar. 6, 2015.
Application No. 14/640,865 is a continuation-in-part of application No. 14/603,227, filed on Jan. 22, 2015.
Application No. 14/603,227 is a continuation-in-part of application No. 14/327,543, filed on Jul. 9, 2014.
(60) Provisional application No. 62/011,574, filed on Jun. 13, 2014.
(60) Provisional application No. 61/844,350, filed on Jul. 9, 2013.
(60) Provisional application No. 61/844,355, filed on Jul. 9, 2013.
(60) Provisional application No. 61/759,314, filed on Jan. 31, 2013.
(60) Provisional application No. 61/759,317, filed on Jan. 31, 2013.
(60) Provisional application No. 61/844,353, filed on Jul. 9, 2013.

(51) Int. Cl. G06N 5/04; G06N 99/00

(52) U.S. Cl. CPC G06N 5/045; G06N 99/005

(57) ABSTRACT

Systems and methods are disclosed that have and implement persona-based decision assistants and graphical user interfaces. The graphical user interfaces may present a view of one or more decision options and may include one or more user-selectable elements through which a selected decision option may be accessed or modified. In certain embodiments, user selections and similar traveler “look-alikes'” purchase behaviors may be processed to refine a persona corresponding to the search, in parallel to a search occurring and after an initial search result has been presented. In certain embodiments, the graphical user interface may show a subset of possible decision options. In certain embodiments, the graphical user interface may provide a selectable element to modify search, persona, and other preferences.

### CROSS-REFERENCE TO RELATED APPLICATIONS

The present application is a nonprovisional of and claims priority to U.S. Provisional Patent Application No. 62/011,574, filed on Jun. 13, 2014, and entitled “Persona-Based Decision Assistants”; and is also a continuation-in-part of and claims priority to U.S. patent application Ser. No. 14/327,543, filed on Jul. 9, 2014, and entitled “Computer-Aided Decision Systems,” which is a continuation-in-part of and claims priority to U.S. patent application Ser. No. 14/169,058, filed on Jan. 30, 2014, entitled “VIRTUAL PURCHASING ASSISTANT”, which claimed priority to U.S. Provisional Patent Application No. 61/759,314, filed on Jan. 31, 2013, and entitled “VIRTUAL PURCHASING ASSISTANT”; and is also a continuation-in-part of and claims priority to U.S. patent application Ser. No. 14/169,060 filed on Jan. 30, 2014, entitled “DUAL PUSH SALES OF TIME SENSITIVE INVENTORY”, which claimed priority to U.S. Provisional Patent Application No. 61/759,317, filed on Jan. 31, 2013, and entitled “DUAL PUSH SALES OF TIME SENSITIVE INVENTORY”; and is also a non-provisional of and claims priority to U.S. Provisional Patent Application No. 61/844,355, filed on Jul. 9, 2013, entitled “INVENTORY SEARCHING WITH AN INTELLIGENT RECOMMENDATION ENGINE”; is also a non-provisional of and claims priority to U.S. Provisional Patent Application No. 61/844,353, filed on Jul. 9, 2013, entitled “SINGLE PAGE TRAVEL SEARCH AND RESULTS MODIFICATION”; and is also a non-provisional of and claims priority to U.S. Provisional Patent Application No. 61/844,350, filed on Jul. 9, 2013, entitled “SEARCHING FOR INVENTORY USING AN ARTIFICIAL INTELLIGENCE PRIORITIZATION ENGINE”; and is also a continuation-in-part of and claims priority to U.S. patent application Ser. No. 14/640,865 filed on Mar. 6, 2015, entitled “PURCHASING FEEDBACK SYSTEM”; and is also a continuation-in-part of and claims priority to U.S. patent application Ser. No. 14/603,227 filed on Jan. 22, 2015, entitled “INTELLIGENT PROPERTY RENTAL SYSTEM”; the contents of all of which are hereby incorporated by reference in their entireties.

### FIELD

The present disclosure is generally related to systems and methods of learning decision systems and graphical user interfaces to present decision option results.

### BACKGROUND

An example of a decision process is that of selecting and purchasing airline flights. Current systems for assisting in the purchase of an item typically take the form of a search performed by the potential customer that yields a snapshot of inventory offerings at that moment in time. Once that search snapshot is displayed, the potential customer is made aware of what is available at that moment in time. However, this search often yields few, if any, results that are useful for the ever changing demands of a user.

### SUMMARY

In certain embodiments, a persona-based decision assistant, operating on a computing device, such as a smart phone, tablet, laptop, smart watch, augmented or virtual reality device, or other computing system, may provide decision option results customized for a particular user-based on a persona. In certain embodiments, an entity, such as a user, a corporation, a group, or other unit may have one or more associated personas, and each persona may be defined both by a self-created profile along with, over time, through explicit, implicit, and inferred information about the entity and the entity's interaction history.

Systems and methods are disclosed below that have and implement persona-based decision assistants and graphical user interfaces. The graphical user interfaces may present a view of one or more decision option results and may include one or more user-selectable elements through which a selected result may be accessed or modified. In certain embodiments, user selections may be processed to refine a persona corresponding to decision making; in addition, many other factors may also be used to allow a persona to learn a user's preferred decision making. In certain embodiments, the graphical user interface may show a subset of possible decision option results. In certain embodiments, the graphical user interface may provide a selectable element to modify search, persona, and other preferences.

### BRIEF DESCRIPTION OF THE DRAWINGS

FIG. 1 is a block diagram of a system including a computing system including a learning decision system that can implement a graphical search interface according to certain embodiments;

FIG. 2 is a diagram of a learning decision system with a graphical search interface, according to certain embodiments;

FIG. 3 is a diagram of a learning decision system with a graphical search interface, according to certain embodiments;

FIG. 4 is a diagram of a learning decision system with a graphical search interface, according to certain embodiments;

FIG. 5 is a diagram of a learning decision system with a graphical search interface, according to certain embodiments;

FIGS. 6A and 6B are diagrams of a learning decision system with a graphical search interface, according to certain embodiments;

FIGS. 7A and 7B are diagrams of a learning decision system with a graphical search interface, according to certain embodiments;

FIGS. 8A and 8B are diagrams of a learning decision system with a graphical search interface, according to certain embodiments;

FIG. 9 is a diagram of a learning decision system with a graphical search interface, according to certain embodiments;

FIG. 10 is a diagram of a learning decision system with a graphical search interface, according to certain embodiments;

FIG. 11 is a diagram of a learning decision system with a graphical search interface, according to certain embodiments;

FIG. 12 is a diagram of a learning decision system with a graphical search interface, according to certain embodiments;

FIG. 13 is a diagram of a learning decision system with a graphical search interface, according to certain embodiments;

FIG. 14 is a diagram of a learning decision system with a graphical search interface, according to certain embodiments;

FIG. 15 is a diagram of a learning decision system with a graphical search interface, according to certain embodiments;

FIG. 16 is a diagram of a learning decision system with a graphical search interface, according to certain embodiments;

FIG. 17 is a diagram of a learning decision system with a graphical search interface, according to certain embodiments;

FIG. 18 is a diagram of a learning decision system with a graphical search interface, according to certain embodiments;

FIG. 19 is a diagram of a learning decision system with a graphical search interface, according to certain embodiments;

FIG. 20 is a diagram of a learning decision system with a graphical search interface, according to certain embodiments;

FIG. 21 is a diagram of a learning decision system with a graphical search interface, according to certain embodiments;

FIG. 22 is a diagram of a learning decision system with a graphical search interface, according to certain embodiments;

FIG. 23 is a diagram of a learning decision system with a graphical search interface, according to certain embodiments;

FIG. 24 is a diagram of a learning decision system with a graphical search interface, according to certain embodiments;

FIG. 25 is a diagram of a learning decision system with a graphical search interface, according to certain embodiments;

FIG. 26 is a diagram of a learning decision system with a graphical search interface, according to certain embodiments;

FIGS. 27A and 27B are diagrams of a learning decision system with a graphical search interface, according to certain embodiments;

FIG. 28 is a diagram of a learning decision system with a graphical search interface, according to certain embodiments;

FIG. 29 is a diagram of a learning decision system with a graphical search interface, according to certain embodiments;

FIG. 30 is a diagram of a learning decision system with a graphical search interface, according to certain embodiments;

FIG. 31 is a diagram of a learning decision system with a graphical search interface, according to certain embodiments;

FIG. 32 is a diagram of a learning decision system with a graphical search interface, according to certain embodiments;

FIG. 33 is a diagram of a learning decision system with a graphical search interface, according to certain embodiments;

FIG. 34 is a diagram of a learning decision system with a graphical search interface, according to certain embodiments;

FIG. 35 is a diagram of a learning decision system with a graphical search interface, according to certain embodiments;

FIG. 36 is a diagram of a learning decision system with a graphical search interface, according to certain embodiments;

FIG. 37 is a diagram of a learning decision system with a graphical search interface, according to certain embodiments;

FIG. 38 is a diagram of a learning decision system with a graphical search interface, according to certain embodiments;

FIG. 39 is a diagram of a learning decision system with a graphical search interface, according to certain embodiments;

FIG. 40 is a diagram of a learning decision system with a graphical search interface, according to certain embodiments;

FIG. 41 is a diagram of a learning decision system with a graphical search interface, according to certain embodiments;

FIG. 42 is a diagram of a learning decision system with a graphical search interface, according to certain embodiments;

FIG. 43 is a diagram of a learning decision system with a graphical search interface, according to certain embodiments;

FIG. 44 is a diagram of a learning decision system with a graphical search interface, according to certain embodiments;

FIG. 45 is a diagram of a learning decision system with a graphical search interface, according to certain embodiments;

FIG. 46 is a diagram of a learning decision system with a graphical search interface, according to certain embodiments;

FIG. 47 is a diagram of a learning decision system with a graphical search interface, according to certain embodiments;

FIG. 48 is a diagram of a learning decision system with a graphical search interface, according to certain embodiments;

FIG. 49 is a diagram of a learning decision system with a graphical search interface, according to certain embodiments;

FIG. 50 is a diagram of a learning decision system with a graphical search interface, according to certain embodiments;

FIG. 51 is a diagram of a learning decision system with a graphical search interface, according to certain embodiments;

FIG. 52 is a diagram of a learning decision system with a graphical search interface, according to certain embodiments;

FIG. 53 is a diagram of a learning decision system with a graphical search interface, according to certain embodiments;

FIG. 54 is a diagram of a learning decision system with a graphical search interface, according to certain embodiments;

FIG. 55 is a diagram of a learning decision system with a graphical search interface, according to certain embodiments;

FIG. 56 is a diagram of a learning decision system with a graphical search interface, according to certain embodiments;

FIG. 57 is a diagram of a learning decision system with a graphical search interface, according to certain embodiments;

FIG. 58 is a diagram of a learning decision system with a graphical search interface, according to certain embodiments;

FIG. 59 is a diagram of a learning decision system with a graphical search interface, according to certain embodiments;

FIG. 60 is a diagram of a learning decision system with a graphical search interface, according to certain embodiments;

FIG. 61 is a diagram of a learning decision system with a graphical search interface, according to certain embodiments;

FIG. 62 is a diagram of a learning decision system with a graphical search interface, according to certain embodiments;

FIG. 63 is a diagram of a learning decision system with a graphical search interface, according to certain embodiments;

FIG. 64 is a diagram of a learning decision system with a graphical search interface, according to certain embodiments;

FIG. 65 is a diagram of a learning decision system with a graphical search interface, according to certain embodiments;

FIG. 66 is a diagram of a learning decision system with a graphical search interface, according to certain embodiments;

FIG. 67 is a diagram of a learning decision system with a graphical search interface, according to certain embodiments;

FIG. 68 is a diagram of a learning decision system with a graphical search interface, according to certain embodiments; and

FIG. 69 is a flowchart of a method of a learning decision system search query, according to certain embodiments.

### DETAILED DESCRIPTION OF ILLUSTRATIVE EMBODIMENTS

In the following detailed description of the embodiments, reference is made to the accompanying drawings, which form a part hereof, and in which are shown by way of illustrations. It is to be understood that features of the various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

In accordance with various embodiments, the methods and functions described herein may be implemented as one or more software programs running on a computer processor or controller. In accordance with another embodiment, the methods and functions described herein may be implemented as one or more software programs running on a computing device, such as a laptop or tablet computer. Further examples of computer devices that may implement the methods and functions described herein include smart devices, such as smart phones and smart watches, wearable computers, such as glasses with an optical head-mounted display, and augmented and virtual reality devices. Dedicated hardware implementations including, but not limited to, application specific integrated circuits, programmable logic arrays, and other hardware devices can likewise be constructed to implement the methods and functions described herein. Further, the methods described herein may be implemented as a computer memory or memory device storing instructions that when executed cause a processor to perform the methods. Instructions for performing the methods disclosed herein may also be broadcast to a device for execution, such as by receiving the instructions from a server and storing them in a memory for execution.

In certain embodiments, a computing system may be configured to implement a persona-based decision assistant. The persona-based decision assistant may be configured to receive decision option results from one or more data sources and to provide decision option results organized or selected according to a persona. While certain embodiments are described herein with respect to travel, such are merely examples to allow the reader an understanding of the application of persona-based decision systems and methods; whereas, persona-based decision assistants can be used for any type of decision making. A persona may be considered a human mimicking digital persona that is able to dynamically evolve and learn; that is, a persona may be an intelligent agent in an augmented intelligence system, of which an artificial intelligence system may be a part. Further, personas can operate like synapses across functionalities; that is, a persona can learn or operate via multi-discipline synapses that can transfer relevant information and decision-making behaviors between functionalities (e.g. implementations of a persona or a different persona) and verticals (e.g. implementations of a persona or a different persona) to learn from each other. For example, real estate choices or decisions can be weighed or narrowed down to the most relevant options due (e.g. in part to) a persona's travel preferences, past purchases, peer group/network/cohort and behaviors, and vice versa. This way a digital persona is transferable and useful across multiple disciplines and decision-making systems.

In an example where a commodity to be purchased includes plane tickets, the persona may be a business persona or a personal persona. The user may interact with a user interface of the computing system to indicate the basis for the trip (business or personal), and the computing system may retrieve the corresponding persona in order to weigh search results, to customize the presentation of search results, or any combination thereof.

As used herein, the term “persona” refers to a set of preferences, rules, behaviors, and historical decisions/purchases corresponding to an entity. The persona may be developed over a period of time based on user interactions, including explicit and implicit user feedback, purchases, selections, and further information derived from interactions with the system. The entity may be an individual, a group, a corporation, or some other organization. Each entity may have one or more personas. Each persona is associated with a “brain”, which may be understood to be an instantiation of an augmented intelligence (AI) agent configured according to the persona and adapted to perform various operations on behalf of the entity and in response to inputs from the entity. A persona may include a digital representation of an individual consumer, a groups of consumers, an organization, one or more other entities, or any combination thereof. Further, a persona may include multiple sub-personas that may apply to desired outcomes in certain instances, such as a vacation sub-persona, a work sub-persona, a geography based sub-persona, a group based sub-persona, and various other possibilities.

The computing system may execute an application that utilizes the persona associated with the entity to weigh, rank, and present outcome based results in a manner that may be customized for the particular entity and according to the particular context of a persona, one facet of which may be a search. An AI outcome determination system, as described herein may be present outcome choices to a user based on a desired outcome rather than based merely on a search performed by the user.

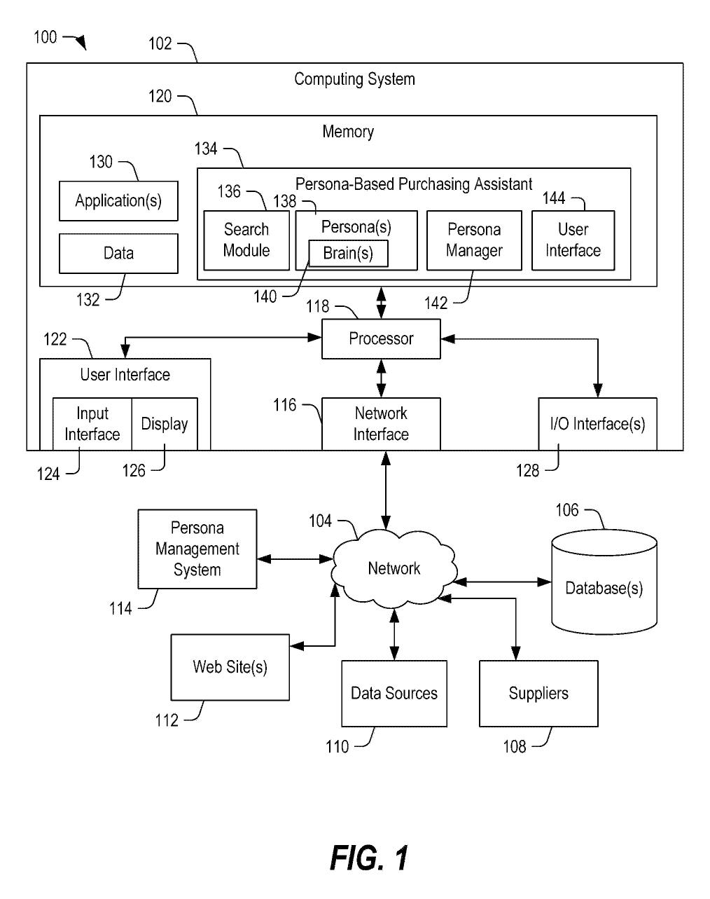

FIG. 1 is a block diagram of a system 100 including a computing system 102 to provide a persona-based decision assistant according to certain embodiments. The system 100 may be coupled to one or more databases 106, one or more suppliers 108, one or more data sources 110, one or more web sites 112, and a persona management system 114 through a network 104.

The computing system 102 may be any type of computing device that may be configured to execute instructions, process data, and provide a data output. Examples of computing devices that may be used to implement the computing system 102 include, but are not limited to, desktop computers, laptop computers, tablet computers, personal digital assistants, smart phones, smart watches, wearable computers, virtual reality devices, and the like. The computing system 102 may include a network interface 116 configured to communicate with the network 104 through a wired or wireless communications link. The computing system 102 may further include a processor 118, which may be coupled to the network interface 116. The computing system 102 may also include a memory 120, a user interface 122, and an input/output interface 128, which may be coupled to the processor 118.

The user interface 122 may include an input interface 124 to receive user inputs and a display 126. In certain embodiments, the user interface 122 may be a touch screen. A microphone may also be included to receive voice input commands from a user. In certain embodiments, a speaker and microphone connected to the computing system 102 may be used for the computing system 102 to speak to a user and solicit information via voice response from the user; which may be done within the user interface 122 or separate from the user interface 122.

In certain embodiments, the I/O interface 128 may include a port to couple to an external device through a wired connection, such as a universal serial bus (USB) cable. In addition or in the alternative, the I/O interface 128 may include one or more transceivers configured to communicate with an external device through a wireless communication link, such as a short-range wireless link.

The memory 120 may store data 132 and may store instructions (such as applications 130 and persona-based decision assistant 134) that, when executed, cause the processor 118 to perform a variety of functions. In certain embodiments, the persona-based decision assistant 134 may include a search module 136 that, when executed, causes the processor 118 to generate a query and to retrieve search results according to the query. In certain embodiments, the query may be generated in response to a user input.

The persona-based decision assistant 134 may also include a plurality of persona(s) 138, which may have been generated locally or received from an external device, such as the persona management system 114. Each persona 138 may include a “brain” 140, which may be understood to be an instantiation of an augmented intelligence (AI) agent configured according to the information associated with the persona 138. An AI agent may include an artificial intelligence system(s), a machine learning system(s), historical data analysis system(s), or other systems that allow the AI agent to provide intelligence based outcomes. The persona-based decision assistant 134 may also include a persona manager 142 that, when executed, causes the processor 118 to select a suitable one of the plurality of personas 138 and to apply the selected persona to weigh search results and to provide a user interface 144 including the search results organized based on the selected persona. The user interface 144 may include one or more user-selectable elements (buttons, clickable links, pull-down menus, slider bars, check boxes, radio buttons, text fields, or other elements) accessible to further refine the search results, to make selections and optionally to purchase a product or service listed within the search results. The user interface may also be configured to receive voice input from a microphone. A speech-to-text conversion module, for example executable by the processor 118, may show the voice input as text at the user interface 144.

In certain embodiments, the computing system 102 may receive data from the one or more databases 106, the suppliers 108, the data sources 110, the websites 112, or any combination thereof. The computing system 102 may also receive a persona corresponding to an entity from the persona management system 114. The computing system 102 may selectively weigh and organize the data according to the persona and may provide a graphical user interface (GUI) including the weighed data to an output, such as the user interface 122. The GUI may include one or more user-selectable elements accessible via the user interface 122 to refine the weighed data, to alter search criteria, to save selected results, and to interact with a particular search result.

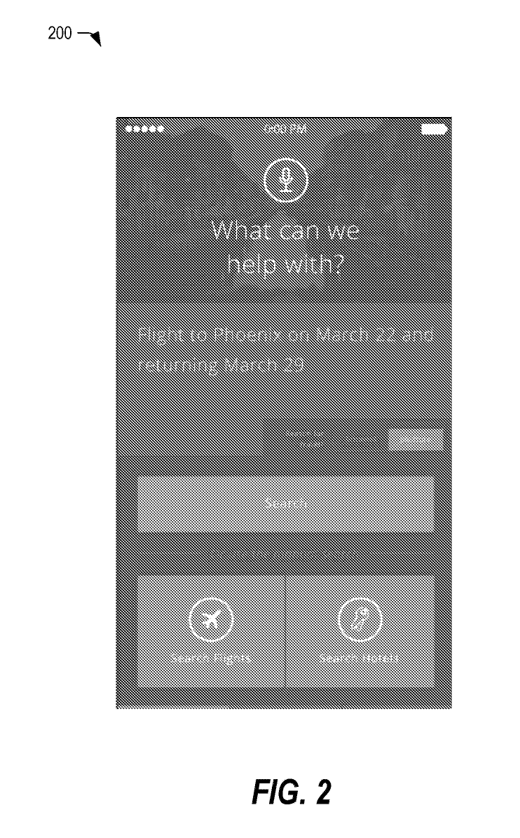

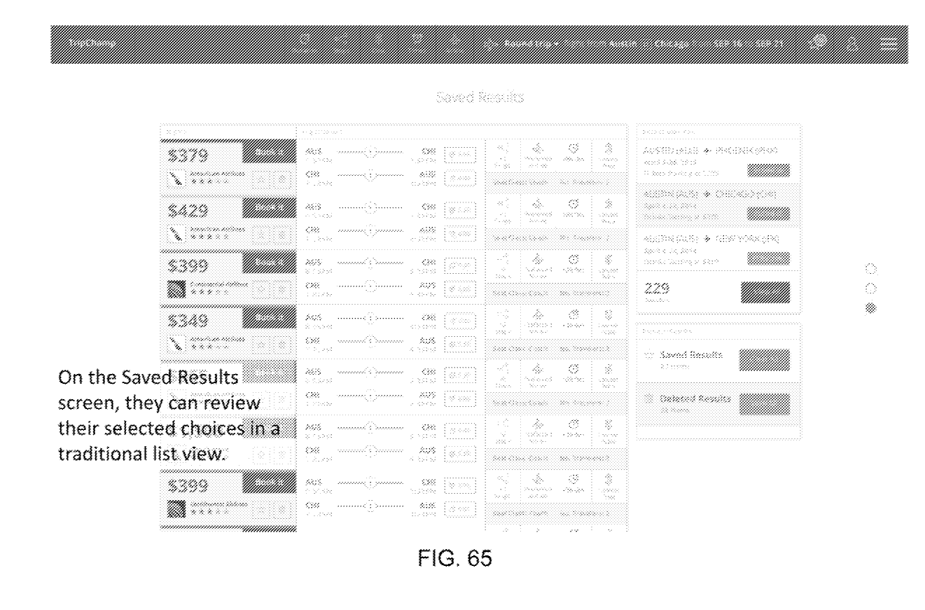

In certain embodiments, the persona-based decision assistant 134 may be configured for travel, such as to book airline tickets. In such an example, the persona-based decision assistant 134 may provide a GUI to the user interface 122. Example embodiments of GUIs that may be provided by the computing system 102 executing the persona-based decision assistant 134 configured for travel purchases are provided in FIGS. 2-65. The persona-based decision assistant 134 may receive user input corresponding to the GUI and may receive search results and a selected persona. The persona-based decision assistant 134 may weigh the search results according to the selected persona and the system's group intelligence based on past purchasing behavior of virtual “look alikes” or cohorts and may present the weighed search results, ranked and/or otherwise organized, according to the persona.

In an example, the persona may specify a relative importance of particular purchase decisions, such as price, location, company (e.g. brand, distributor, supplier, etc.), and so on. A persona may also learn a user's unstructured preferences; that is, information that might not neatly fit into a classic search request or filtering. For example, unstructured preferences may include a type of plane, a size of hotel room, cleanliness of a neighborhood, indications of a child friendly or pet friendly hotel, or otherwise. An entity may prefer one airline over another, or one airline over another on certain routes or domestically or internationally and such preference may be reflected in the persona. Additionally, an entity may have more than one persona. For example, a person may have one persona corresponding to his purchase decisions made on behalf of an organization, and may have a second persona corresponding to his personal purchase decisions. Additionally, an entity may have a family persona, an “on vacation” persona, an “at home” persona, and so on. Depending on the entity, the number of personas may expand over time and in some instances may be combined as more information is gathered. In certain embodiments, the persona-based decision assistant 134 may duplicate an existing persona and modify the duplicate persona according to received information to provide a new persona customized for a particular context. The context may be determined over a period of time based on analysis of interactions with the system. In certain embodiments, the persona may be expanded or modified as group behavior of similar users or digital “look-alikes” helps further define what “someone like you” would do. A digital look-alike may be personas that have similarities based on profile, behavior, preferences, or any combination thereof.

The GUI may include a text field and other user-selectable elements. The persona-based decision assistant 134 may receive inputs in response to the GUI and may search one or more data sources in response to the inputs. While the search is progressing, the persona-based decision assistant 134 may present one or more selectable options within the GUI, which options correspond to purchase preferences, such as whether a king-sized bed or a queen-sized bed is preferred. The persona-based decision assistant 134 may receive inputs corresponding to the selectable options, which inputs may be used to refine a selected persona. In certain embodiments, the persona-based decision assistant 134 may provide a GUI including a list of personas for selection of the persona for use with the particular search results. In certain embodiments, the GUI including the list of personas may be presented prior to receiving the user inputs, prior to searching the one or more data sources, before presentation of the purchase preferences options, or after receipt of the input corresponding to the purchase preferences. The persona-based decision assistant 134 may weigh search results and organize the weighted search results based on the selected persona. The persona-based decision assistant 134 may take into account time and its impact on the user.

In certain embodiments, the persona-based decision assistant 134 may provide an intelligent, personally targeted, real-time travel services agent tailored specifically to user preferences, behaviors, locations of an entity, or other elements. The persona-based decision assistant 134 may receive a request for travel information (such as plane ticket prices for a specific trip), and the persona-based decision assistant 134 may identify travel information satisfying the request and then may personalize the results based on the persona to present results that correspond to the entity's preferences (e.g., price, departure/arrival times, airline, seat preferences, and so on). The persona-based decision assistant 134 may then present one or more results that have been specifically selected based on the persona. The persona-based decision assistant 134 may also respond to dynamic changes, such as real-time price changes, because the persona-based decision assistant 134 may be continually searching before, during, or after a result is presented to a user.

In certain embodiments, the persona-based decision assistant 134 (or a server based system, such as the persona management system 114) may continue to actively determine and provide better decision options for each user based on the persona. The persona-based decision assistant 134 finds the options that not only satisfy the entity's request, but the persona-based decision assistant 134 attempts to find the results that the entity actually wants, based on previous interactions, group intelligence and learning algorithms of the decision system that allow the personas to dynamically evolve. In certain embodiments, the persona-based decision assistant 134 tracks user interactions and integrates a number of factors to update and enhance the accuracy of the persona over time, such as by integrating: explicit user feedback, implicit/subconscious user feedback (based on length of time on a page, selection of favorites, etc.), purchase decisions, actions, recommendations and purchase history of others in their circle of friends/acquaintances, recommendations of experts, behavior of digital “look-alikes” and so on. The persona-based decision assistant 134 weights these and other factors (both structured and unstructured) across a plurality of actors and behaviors, and then prioritizes those factors to provide results that are at once precise and comprehensive for the particular entity. The persona-based decision assistant 134 may be configured to operate on a full understanding of the entity's changing travel needs at different times, different places, based on different personas—e.g., whether the traveler is traveling on business alone, on leisure with a spouse, or on vacation with kids.

In certain embodiments, the persona-based decision assistant may be configured to operate on behalf of an entity throughout a trip, from the moment of conception to the time that the entity returns. In addition to responding to the traveler's initial query, the persona-based decision assistant 134 may be configured to anticipate, and may act on, the traveler's needs during the course of the trip, such as car rentals, hotel accommodations, and so on. Further, the persona-based decision assistant 134 uses the selected persona and its intelligent processing (brain 140) to determine the entity's “wants” and “needs” at each stage of the trip to provide a desired outcome for the entity. Further, the persona-based decision assistant 134 may act as a digital assistant to offer upgrades, to arrange for VIP lounge access, to reserve seats and tickets and so on.

The persona-based decision assistant 134 can operate around the clock, providing enhancement opportunities for the entity, not just at point of sale or at check in, but throughout and even after the trip, often at heavily discounted prices. The persona-based decision assistant 134 may provide a dynamic spectrum of recommendations, up-sells, cross-sells and value-adds pre-departure, en route, at the destination, or any combination thereof. Further, the persona-based decision assistant 134 can use geo-location and calendar integration to alert the entity to products that tie into products they have purchased and that are most likely to be of interest to them at that point in time and at that location, such as exit rows, business and first class seats, pre-boarding, hotel/car/meal upgrades, add-ons, and to new products, such as lounge access, movies, drinks, in-flight sundries.

FIG. 2 shows an embodiment of a GUI for a persona-based decision assistant that allows a user to search for travel bookings, such as flights or hotels.

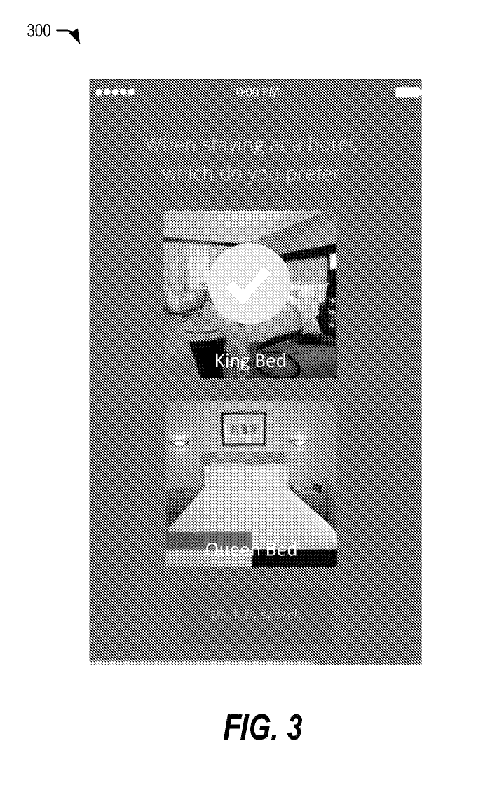

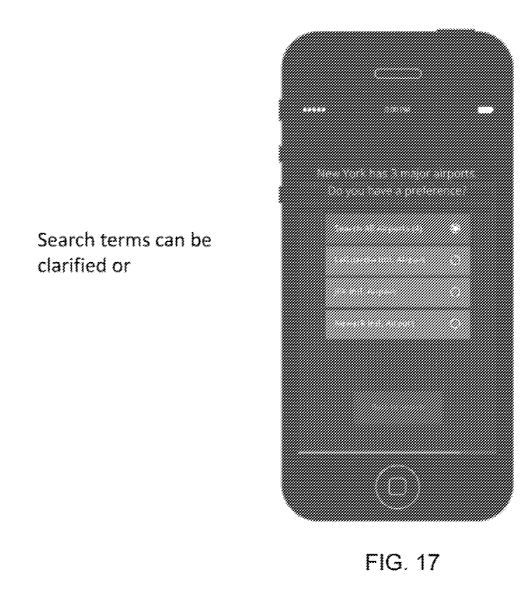

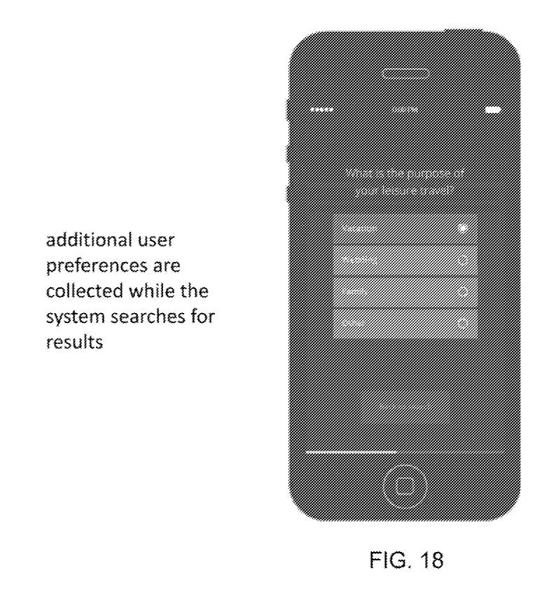

FIG. 3 shows an embodiment of a GUI for a persona-based decision assistant that allows a user to specify options or preferences. The GUI may present one or more options or preferences to the user. In certain embodiments, options or preferences may be presented to the user while a search is being conducted. The selected options or preferences may be incorporated into the pending search before results are transmitted to the user. In certain embodiments, the options or preferences presented to the user may not be directly related to a pending search and may not be incorporated into a pending search, but any selected options or preferences may be saved to a persona (or elsewhere) for later use. FIGS. 17 and 18 also provide further examples of options or preferences that may be displayed to a user while a search is pending, the results of which may be used in a pending search, saved for later, or both.

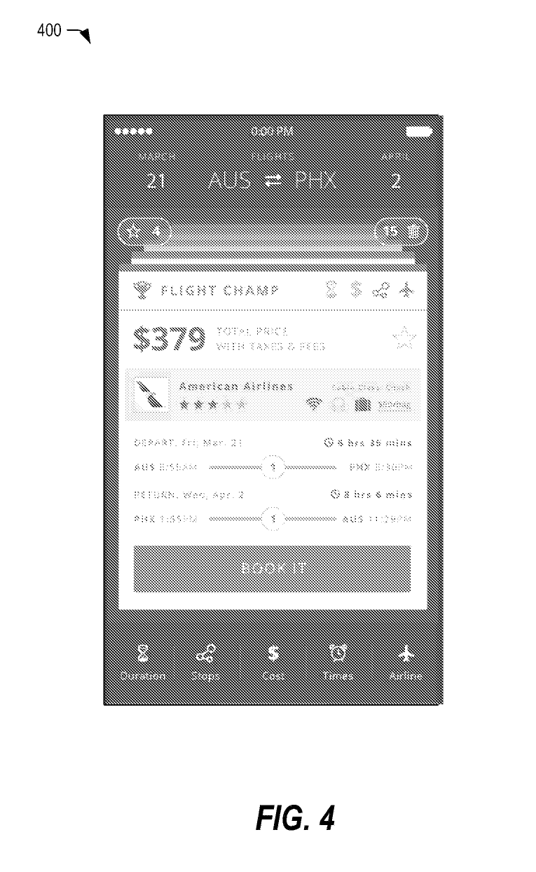

FIG. 4 shows an embodiment of a GUI for a persona-based decision assistant that shows an example search result as a series of overlapping cards. In certain embodiments, each of the result cards may contain a single specific search result for the commodity or product, or may contain more than one search result. In the example depicted, the commodity is an airline flight/ticket. Each of the cards can be a user selectable element, such as by tapping a specific card, swiping downward over a screen, swiping upward over a screen, or swiping left or right across a screen to get to a next card. Each card may represent one or more benefits, such as recommended option, best price, best value, shortest duration, least stops, preferred times, etc.

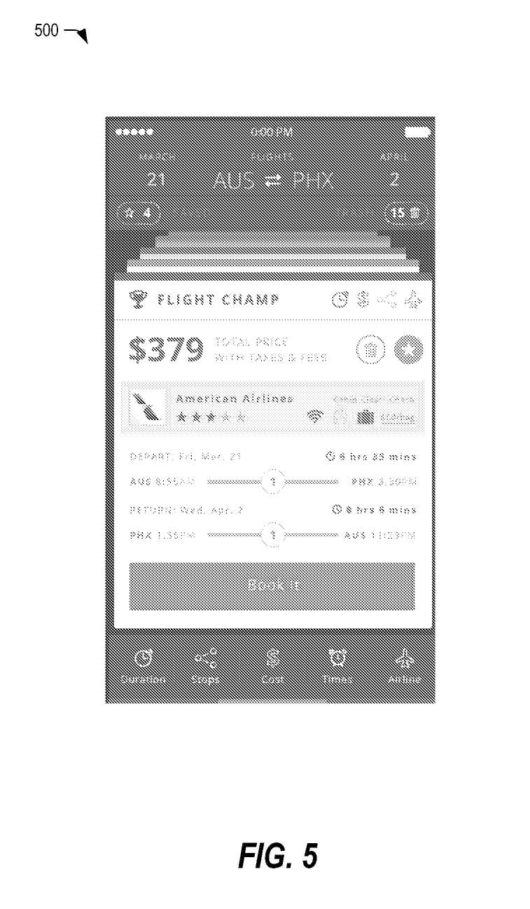

FIG. 5 shows an embodiment of a GUI for a persona-based decision assistant that shows an example search result as a series of overlapping cards. A card may have a user selectable element to purchase or book the commodity (which is an example of a desired outcome). In certain embodiments, a result card may have a user selectable element to save a result. A card may also have a user selectable element to delete or trash a result. The persona-based decision assistant may store data representing saved results or deleted/trashed results and factor such data into future recommendations for the user. A card may also have user selectable elements to further weigh, filter, or modify a search.

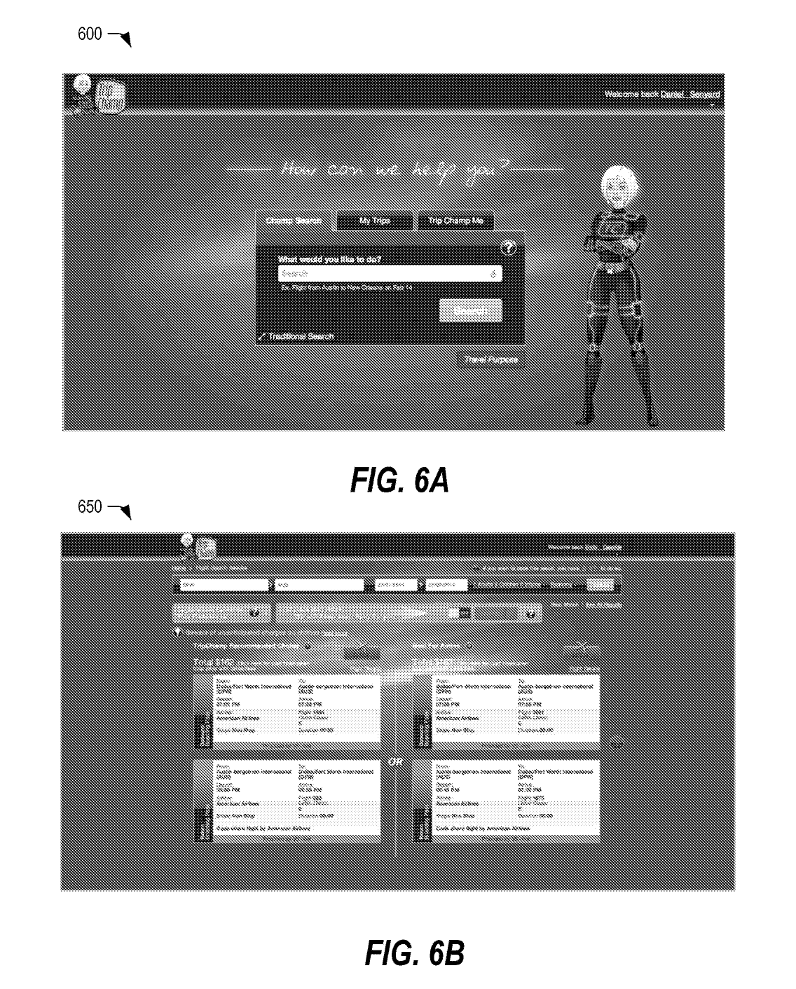

FIG. 6A shows an embodiment of a GUI for a persona-based decision assistant that allows a user to search for travel bookings, such as flights or hotels.

FIG. 6B shows an embodiment of a GUI for a persona-based decision assistant for a persona-based decision assistant that shows an example search result as a series of cards or boxes.

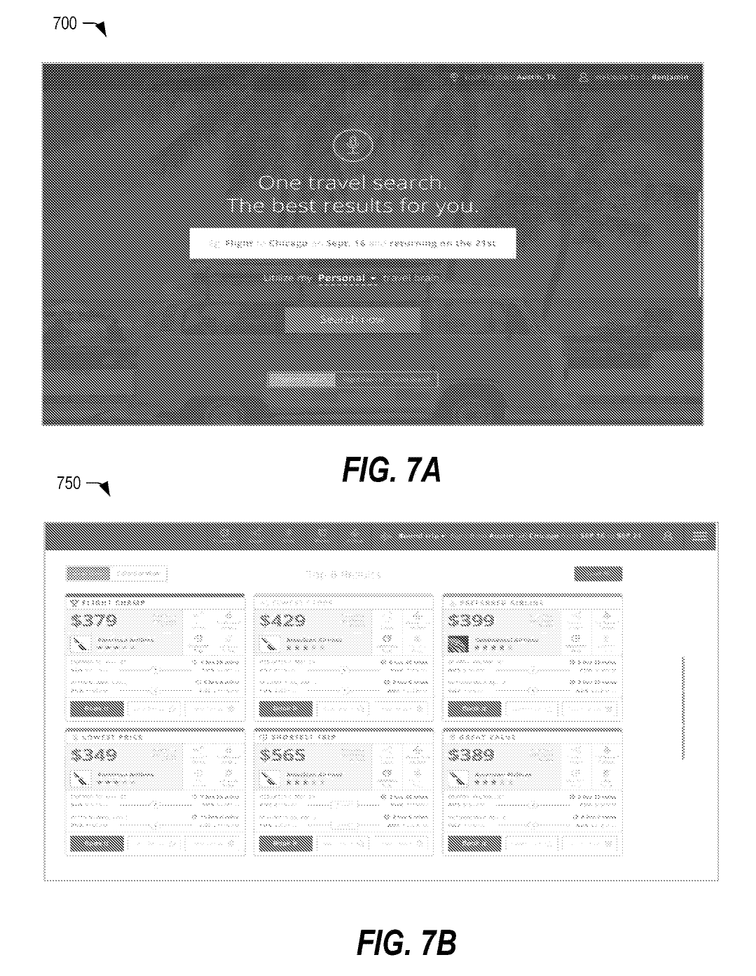

FIG. 7A shows an embodiment of a GUI for a persona-based decision assistant that allows a user to search for travel bookings, such as flights or hotels. The GUI may have a user selectable element that allows a user to select one of multiple personas to apply while performing a search. There may be multiple user input devices and methods, such as a natural-language text interpreter for freeform data entry, voice recognition, buttons, or any combination thereof

FIG. 7B shows an embodiment of a GUI for a persona-based decision assistant that shows an example search result as a series of cards. A card may have a user selectable element to purchase or book the commodity. In certain embodiments, a result card may have a user selectable element to save a result. A card may also have a user selectable element to delete or trash a result. The persona-based decision assistant may store data representing saved results or deleted/trashed results and factor such data into future recommendations for the user. A card may also have user selectable elements to further weigh, filter, or modify a search.

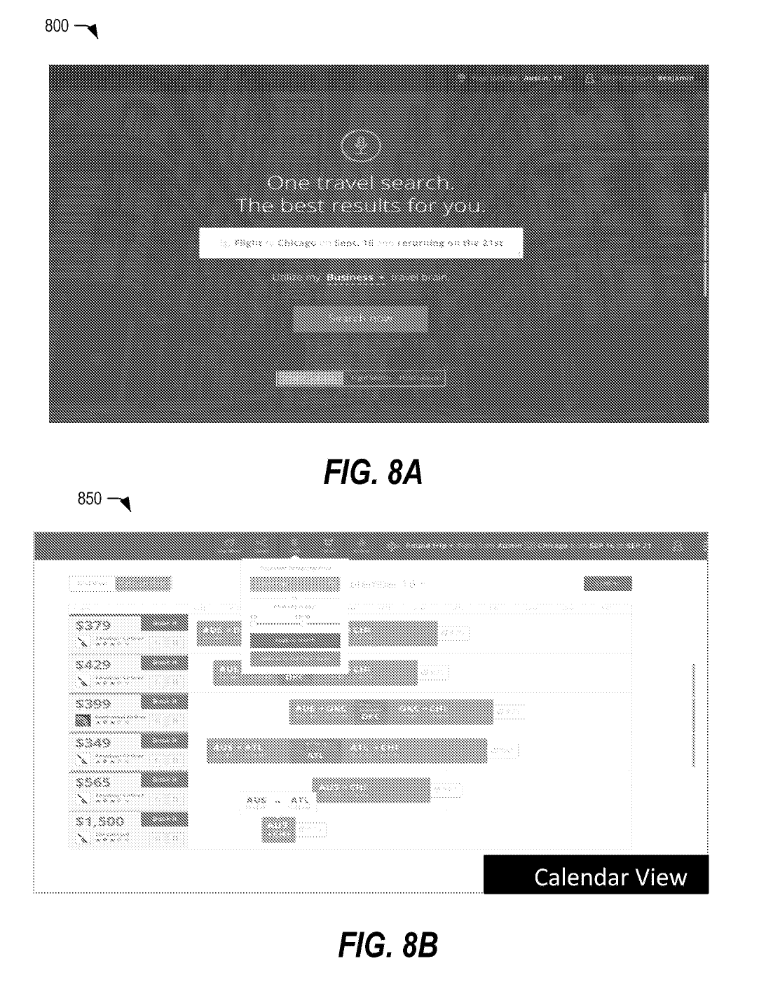

FIG. 8A shows an embodiment of a GUI for a persona-based decision assistant that allows a user to search for travel bookings, such as flights or hotels. The GUI may have a user selectable element that allows a user to select one of multiple personas to apply while performing a search.

FIG. 8B shows an embodiment of a GUI for a persona-based decision assistant for a persona-based decision assistant that shows an example search result as a time-based graph with multiple bars spanning various times. The time-based graph may be color coded to represent various benefits or features. A bar may have a user selectable element to purchase or book the associated commodity. In certain embodiments, a result bar may have a user selectable element to save a result. A bar may also have a user selectable element to delete or trash a result. The persona-based decision assistant may store data representing saved results or deleted/trashed results and factor such data into future recommendations for the user. A bar may also have user selectable elements to further weigh, filter, or modify a search.

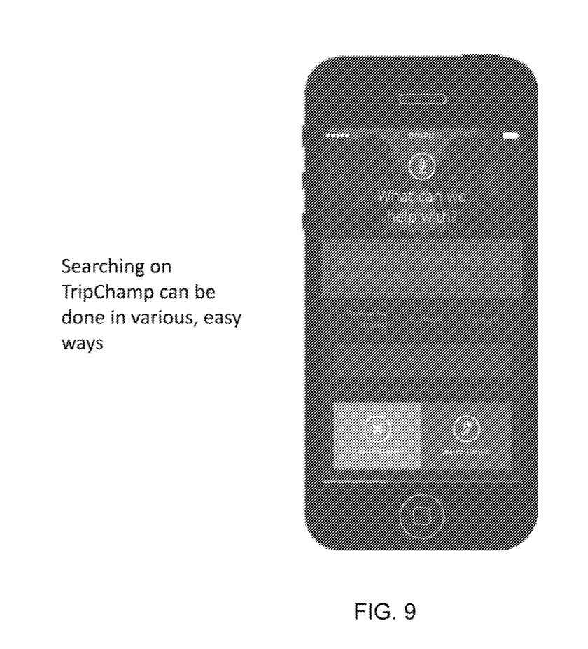

FIG. 9 shows an embodiment of a GUI for a persona-based decision assistant that allows a user to search for travel bookings, such as flights or hotels. The GUI may have a user selectable element that allows the user to specify whether the search is intended for business or personal use.

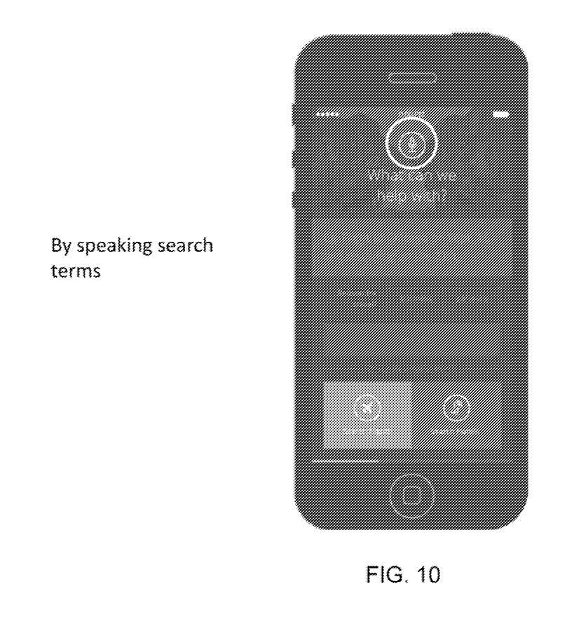

FIG. 10 shows an embodiment of a GUI for a persona-based decision assistant that allows a user to search for travel bookings, such as flights or hotels. A user selectable element may allow the user to input search criteria by voice recognition.

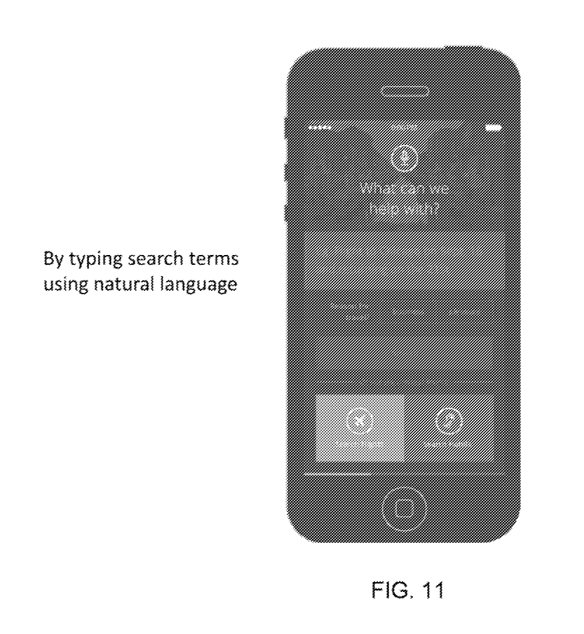

FIG. 11 shows an embodiment of a GUI for a persona-based decision assistant that allows a user to search for travel bookings, such as flights or hotels. A user selectable element may allow the user to input search criteria by typing input. The typing or voice input may be a natural language search.

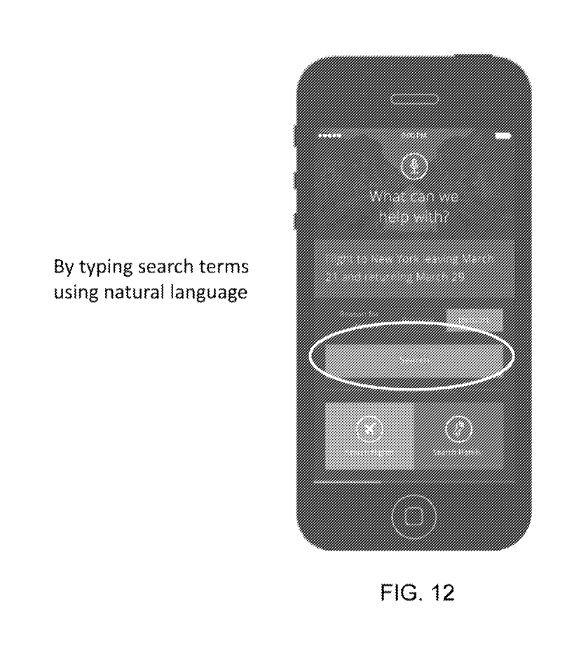

FIG. 12 shows an embodiment of a GUI for a persona-based decision assistant that allows a user to search for travel bookings, such as flights, hotels, attractions and activities. A user selectable element may allow the user to input search criteria by typing input or by voice input. The typing or voice input may be a natural language search. Once a search is input, a user selectable element may be highlighted to allow a user to initiate a search.

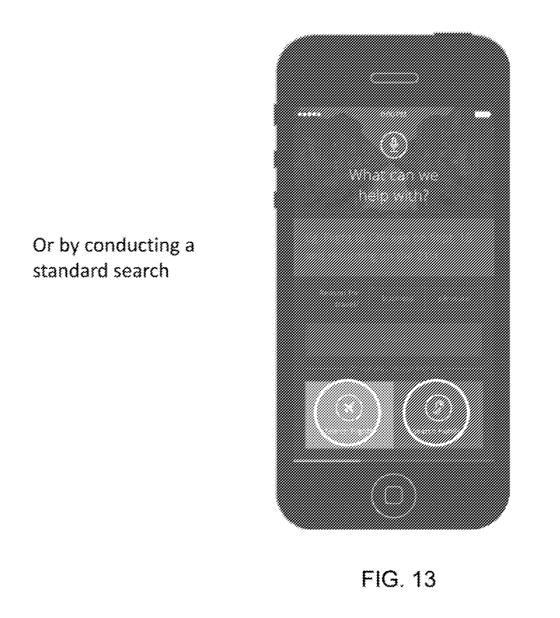

FIG. 13 shows an embodiment of a GUI for a persona-based decision assistant that allows a user to search for travel bookings, such as flights or hotels. A user selectable element may allow the user to select a specific type of search instead of doing a natural language search. For example, a user may select a flight search or a hotel search.

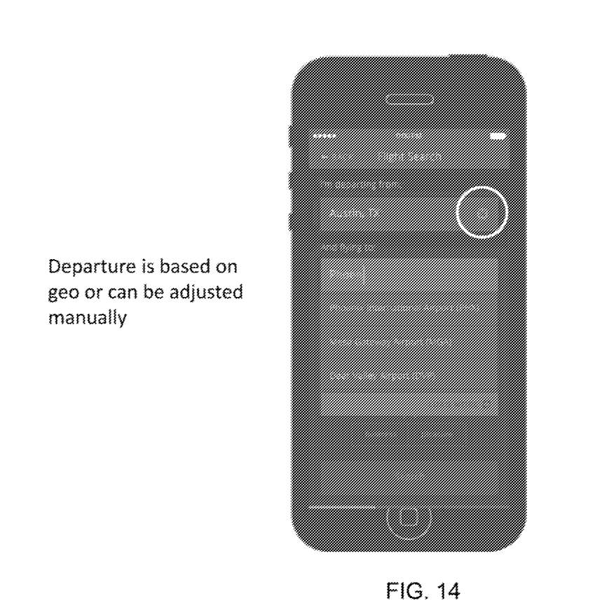

FIG. 14 shows an embodiment of a GUI for a persona-based decision assistant that allows a user to search for travel bookings, such as flights or hotels. A location of a user may be determined from a GPS locator or other position location information accessible to the persona-based decision assistant 134 or the GUI. A user selectable element may allow the user to select a specific location instead of use of the device location.

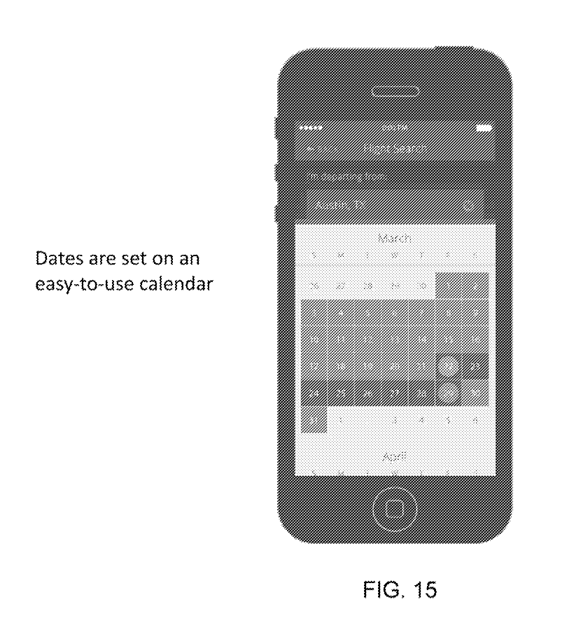

FIG. 15 shows an embodiment of a GUI for a persona-based decision assistant that allows a user to select dates via a calendar. In an example, in response to selecting an element associated with a location, a user may be presented with an option to adjust the location or an option to select the date.

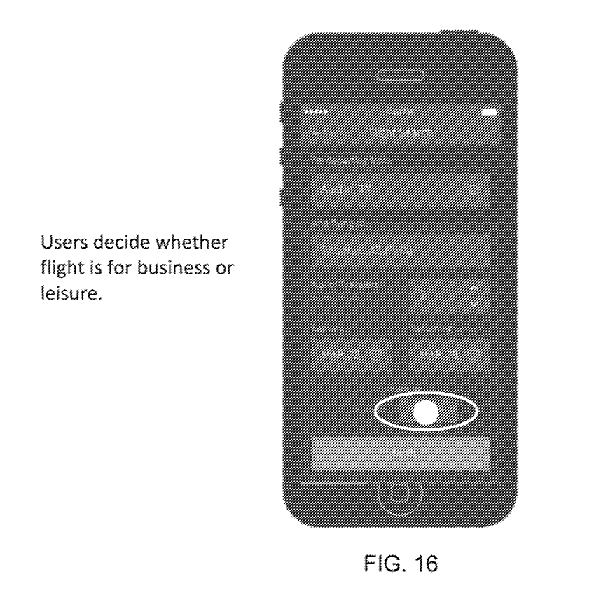

FIG. 16 shows an embodiment of a GUI for a persona-based decision assistant that provides a plurality of user-selectable elements for adjusting the departure location, the arrival location, the number of travelers, the departure date, the departure time, and so forth. Moreover, the GUI includes a pair of buttons accessible by the user to select whether the flight is for business or personal, which selection may assist the persona-based decision assistant 134 to select the appropriate persona for the session.

FIG. 17 depicts an embodiment of a GUI for a persona-based decision assistant that includes user-selectable elements that are accessible to specify whether the user has a preference with respect to the available airports at one or both of the departure location and the arrival location. In the illustrated example, the GUI includes the following information: “New York has 3 major airports. Do you have a preference?” This statement is followed by four selectable options: “Search All Airports,” “LaGuardia International Airport,” “JFK International Airport,” and “Newark International Airport.” The user may specify one of the options, and the travel search may be limited to the selected airports. Moreover, the persona may be updated with this information so that subsequent searches will be similarly restricted.

FIG. 18 shows an embodiment of a GUI for a persona-based decision assistant that collects additional user preference information while the system is searching for available flights that satisfy the search criteria. In this particular example, the GUI includes a question about the purpose of the leisure travel, such as “Vacation,” “Wedding,” “Family,” or “Other.” This additional user preference information may be used by the persona-based decision assistant 134 to recommend additional travel options, such as hotels, rental cars, leisure activities, etc.

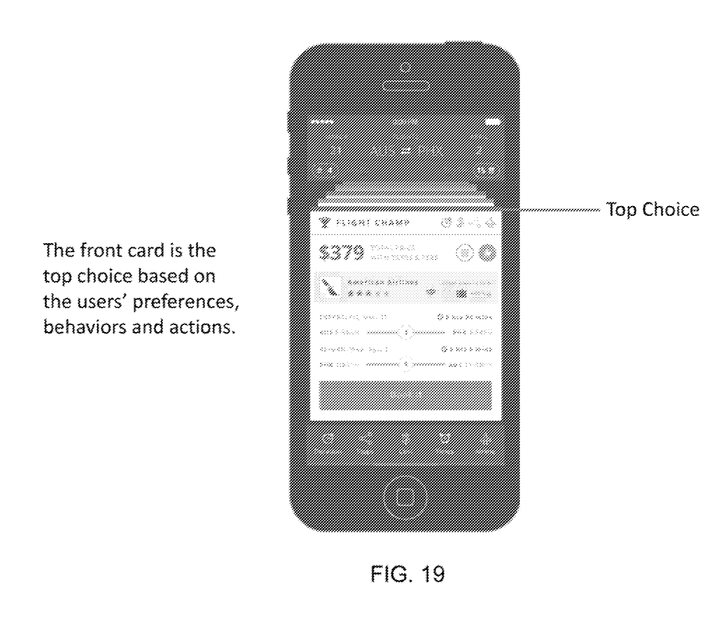

FIG. 19 shows an embodiment of a GUI for a persona-based decision assistant that presents the search results as a plurality of travel cards for a search involving flights between Austin, Tex. and Phoenix, Ariz. departing from Austin, Tex. on March 21 and returning from Phoenix, Ariz. on April 2. Each travel card includes a price, the airline information, and flight information including a flight itinerary having the departure and return flight information including the departure and arrival times and including duration information. Each travel card further includes an option to book the flight.

The travel cards may be sorted into a ranked order based on the persona under which the search was performed (e.g., a business persona, a leisure persona, or some other persona, such as a “leisure plus family” persona). The top choice is based on the persona-based decision assistant's understanding of the user's preferences, which may be a complex mixture of price, preferences and context.

In certain embodiments, the user may interact with the GUI to save a particular search result (such as by clicking a star icon on the travel card) or to discard a particular search result, such as by clicking a trash icon on the travel card. In response to user interactions (explicit feedback) and/or in response to implicit user feedback inferred from, for example, time spent on a particular card or determined from historical information about such explicit and implicit feedback, the persona-based decision assistant 134 may update the persona information to produce a more refined persona that may enhance the user's experience in the future. In certain, embodiments, when a user trashes or discards a certain result, the persona-based decision assistant 134 may present the user, via the GUI, with another determined outcome, such as another travel booking option.

Further, in certain embodiments, the user may scroll or flip through the cards to see other potential itineraries. Further, in certain embodiments, the user may select one of the travel cards, such as by double-tapping the travel card, which may cause the GUI to “flip” the travel card over to show more detailed itinerary information, such as connecting flights, layovers, and other information for the selected travel card. In some embodiments, a single tap may flip a card to show, or not to show, more detailed information.

The GUI may further include a menu bar across the bottom or in another location that may remain accessible across multiple travel cards and that may be accessed by the user to access duration data, stops data, cost data, times data, and airline data and to access and configure user preferences associated with such data. The GUI may also present an option for the user to specify whether the settings should be applied to the current search or applied to global settings for all future searches.

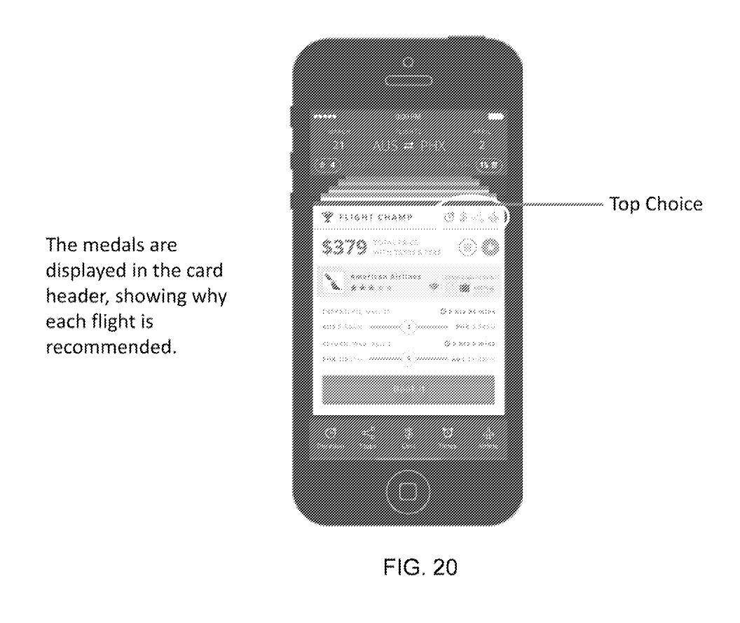

FIG. 20 shows an embodiment of a GUI for a persona-based decision assistant that includes the plurality of travel cards. In the illustrated example, icons at the top of the travel card are indicated, which icons may represent the factors or categories to which the card is associated. For example, the icons may represent associations with certain categories, for example a clock (duration), a dollar sign (cost), a multi-node icon (stops), or an airplane icon (airline). The icons can also be color coded to allow a user to recognize a category relationship based on the color of the icon, e.g. highlighted while others are faded.

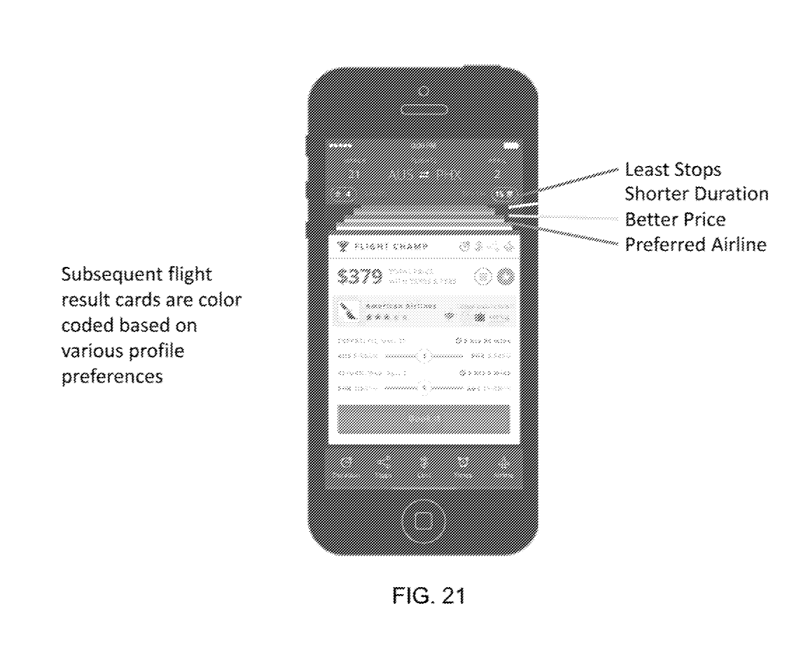

FIG. 21 shows an embodiment of a GUI for a persona-based decision assistant that includes the plurality of travel cards. As shown, each travel card may have an edge that is color coded for a particular category or attribute of the itinerary, such as “Number of Stops,” “Duration,” “Price,” and “Preferred Airline.” The GUI makes it possible for the user to flip through the travel cards quickly based on such preferences in order to quickly view an itinerary that best fits his/her desired travel itinerary.

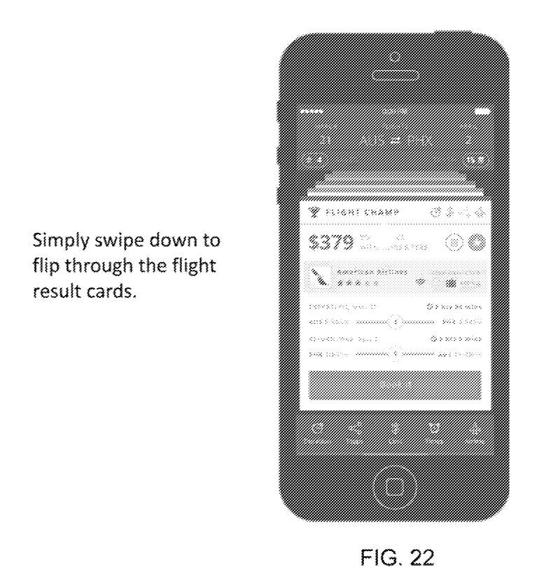

FIG. 22 shows an embodiment of a GUI for a persona-based decision assistant, within which is highlighted a selectable indicator by which the user may access the details of the itinerary. Selection of this selectable indicator may cause the GUI to flip the travel card over or to provide a pop up with user-selectable elements for adjusting selected flight details.

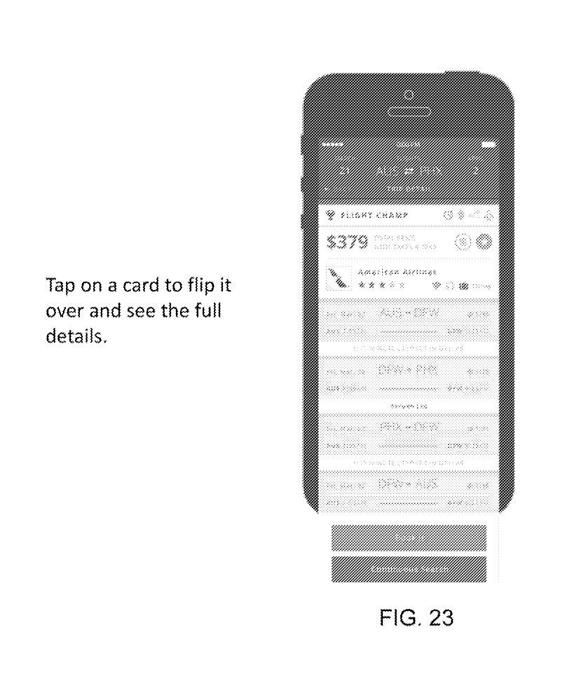

FIG. 23 shows an embodiment of a GUI for a persona-based decision assistant that provides the details of the selected itinerary including departure and arrival times for each leg of the trip. In certain embodiments, the GUI may be the other side of the travel card of FIG. 22. Further, in certain embodiments, the user may select any one of the legs of the itinerary to access details of that portion of the trip and to make changes, such as by searching for a better flight (in terms of time, airline, etc.), upgrading the leg to business class or first class, and so on. The GUI also provides options to book the flight or to task the persona-based decision assistant 134 to continuously search for similar and better itineraries according to the persona.

While the persona-based decision assistant 134 and the associated GUI described above have been directed largely to travel-oriented tasks, it should be appreciated that the functionality of the persona-based system may be extended to other business or leisure sectors or to personal task management.

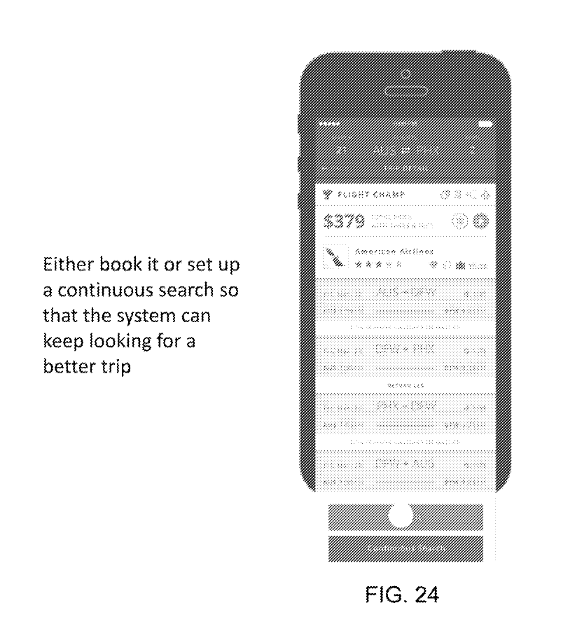

FIG. 24 shows an embodiment of a GUI for a persona-based decision assistant where the user has selected the “Book It” option.

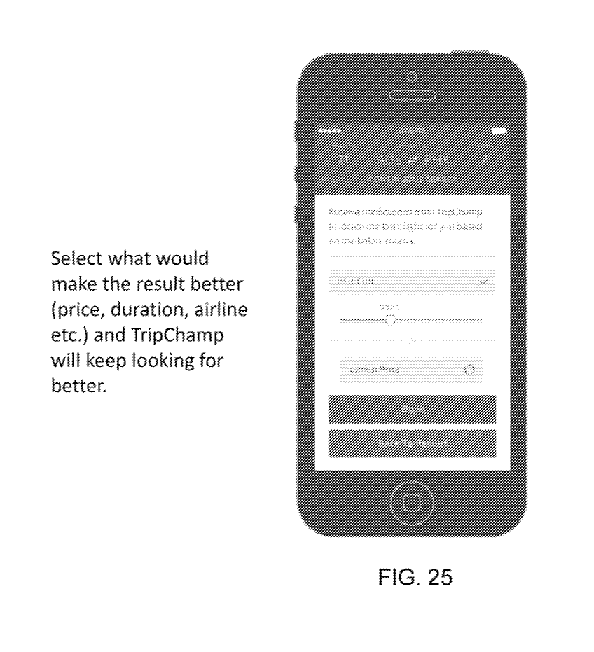

FIG. 25 shows an embodiment of a GUI for a persona-based decision assistant where the “Continuous Search” option is selected in FIG. 23 or 24. In response to the selection, the GUI presents a continuous search option with multiple user-selectable elements. In the illustrated example embodiment, the “Price Goal” option is selected from a pull-down menu, and a slider bar is provided through which a price threshold may be set. In this example embodiment, a user may configure the continuous search to continue to look for a lowest price ticket and to provide a notification or alert when an itinerary is identified that is below the price threshold and that meets the travel criteria specified by the user. A continuous search, or searches, can be set for any desired outcome or product not just travel, and for any factor or combination of factors or for something the system thinks is better. Also, the system can be authorized to book directly when it finds a better desired outcome, such as a different product, using the continuous search if certain requirements are met, such as the user isn't available and the desired outcome has an importance level associated with it greater than a certain threshold. The AI system may assign, based on user feedback or other factors, importance level values to desired outcomes, which can be verified and approved by the user in some instances. The AI system, acting alone or with user input, may determine a threshold importance level to help determine when the AI system may act alone.

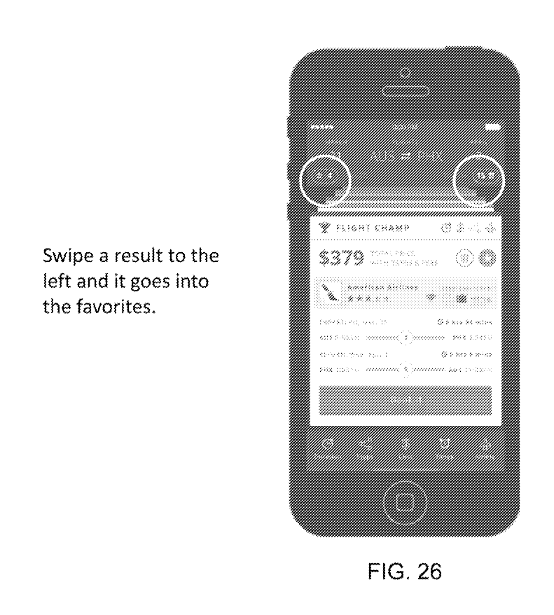

FIG. 26 depicts an embodiment of a GUI for a persona-based decision assistant including the plurality of travel cards and indicators showing a number of saved travel cards and a number of discarded (“Trashed”) travel cards. The user, as he or she flips through the travel cards, may save some and discard others in order to reduce the overall number of itineraries to choose from. Thus, the user may gradually reduce the list to a set of the best itineraries for him/her and may select from that subset.

Over time, the persona-based decision assistant 134 may dynamically evolve, such as by learning and adjusting a persona according to user selections, user inputs, external inputs, other personas, and by refining their own neural networks and artificial intelligence. Subsequent decision option results may provide a more refined set of decision option results that is more closely aligned to the user's preferences.

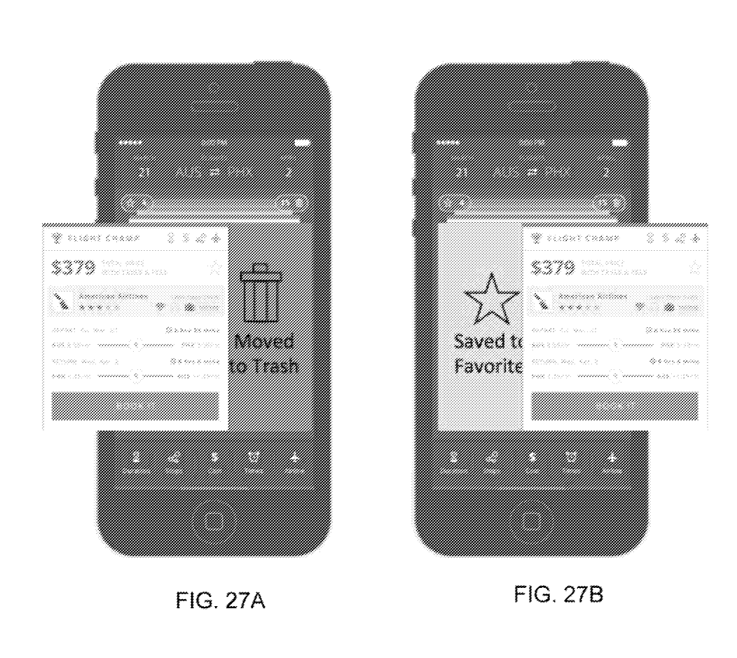

FIG. 27 shows an embodiment of a GUI for a persona-based decision assistant where the user may save or trash a particular travel card by dragging the card in one direction or another. In the illustrated example, dragging the travel card to the left saves the travel card, and dragging the card to the right discards the travel card. Other drag and drop options may also be used.

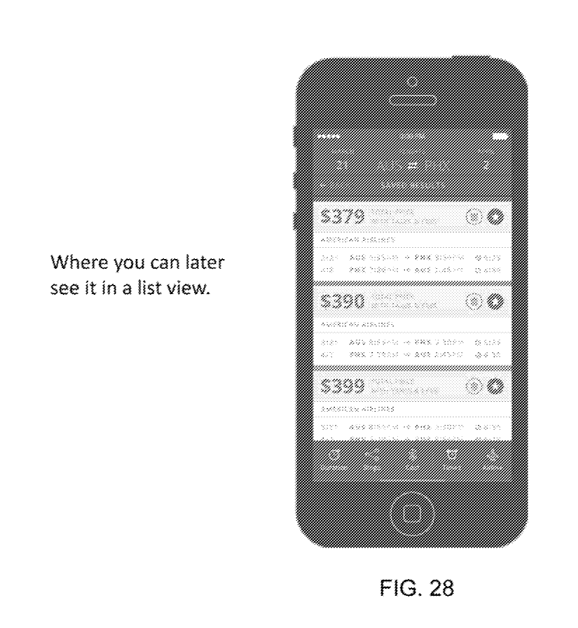

FIG. 28 shows an embodiment of a GUI for a persona-based decision assistant including a list of saved travel cards. The color-coding is preserved at the top of each travel item in the list to provide a visualization of at least one of the attributes of the itinerary.

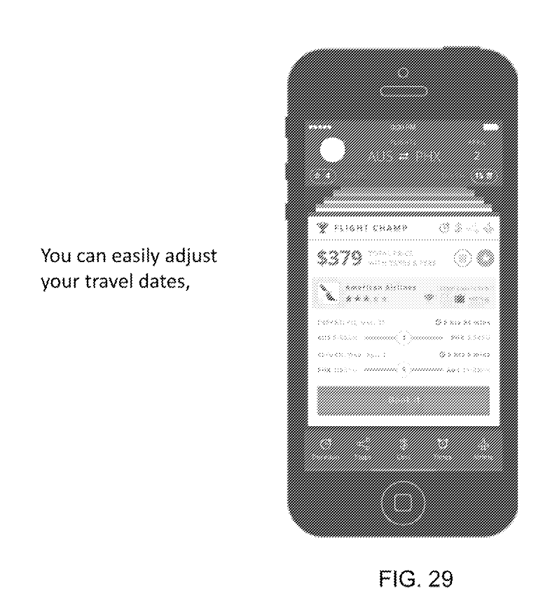

FIG. 29 shows an embodiment of a GUI for a persona-based decision assistant including a user-selection of the date associated with the travel cards. Selection of the date may open a calendar or other feature for the user to quickly adjust the departure date of the flights without altering other parameters of the search in order to determine a new set of itineraries. Similarly, the return date may also be selectable to adjust the date.

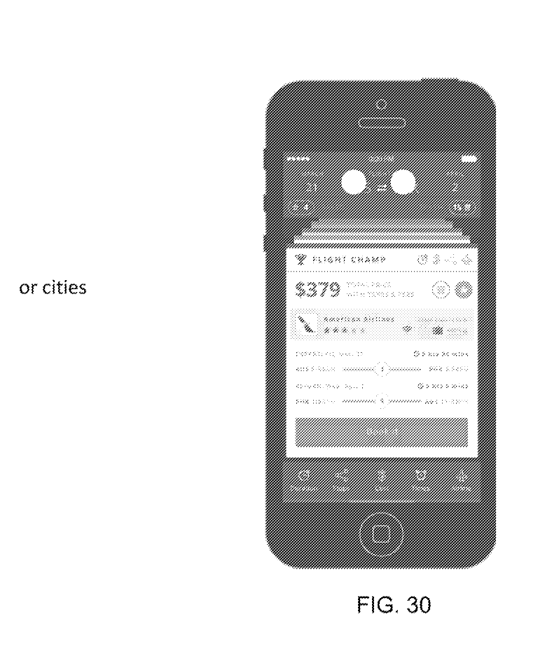

FIG. 30 shows an embodiment of a GUI for a persona-based decision assistant highlighting the departure city and the destination city, which are also selectable by the user to alter the departure or destination cities without altering other parameters of the search in order to determine a new set of itineraries.

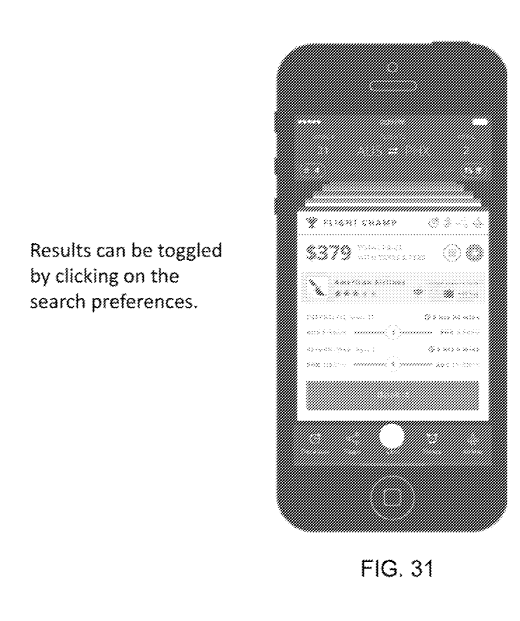

FIG. 31 shows an embodiment of a GUI for a persona-based decision assistant including user selection of a “Cost” option, which allows the user to customize the search results according to price.

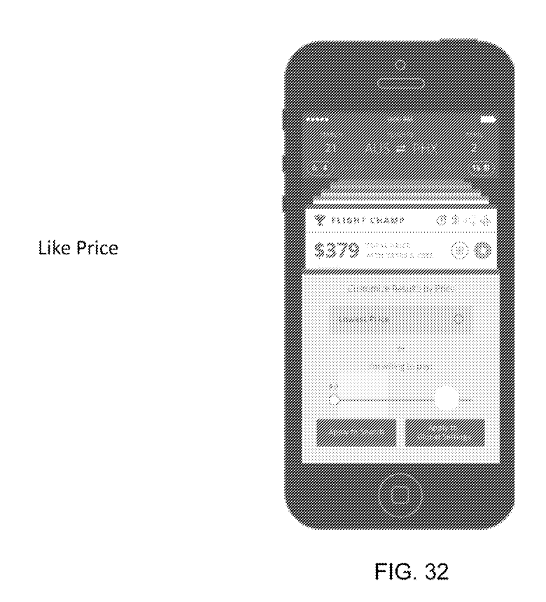

FIG. 32 shows an embodiment of a GUI for a persona-based decision assistant that allows the user to configure a customized search by price option, either selecting a “lowest price” option or configuring an amount “I'm willing to pay”, which may include a slider bar or text input field. The GUI also presents an option for the user to specify whether the settings should be applied to the current search or applied to global settings for all future searches.

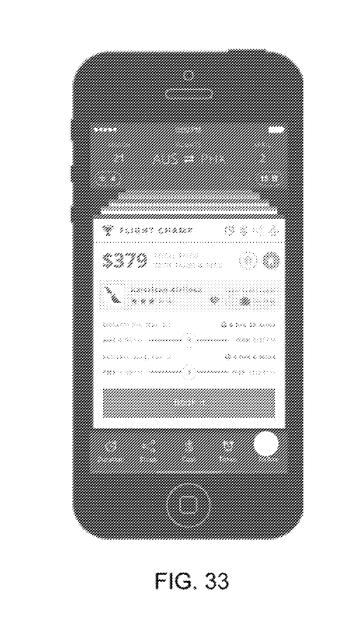

FIG. 33 shows an embodiment of a GUI for a persona-based decision assistant including user selection of an “Airline” option, which allows the user to customize the search results according to the airline.

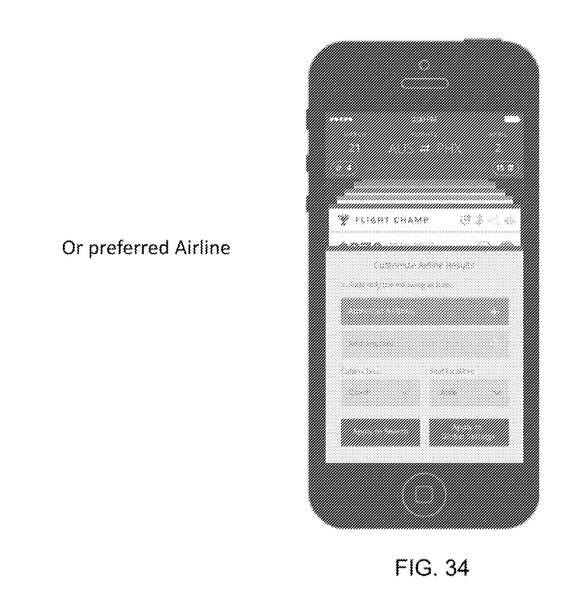

FIG. 34 shows an embodiment of a GUI for a persona-based decision assistant including user-selectable options to specify a list of acceptable airlines as well as class (first class, business class, premium economy or coach class) and preferred seat location information. The GUI also presents an option for the user to specify whether the settings should be applied to the current search or applied to global settings for all future searches.

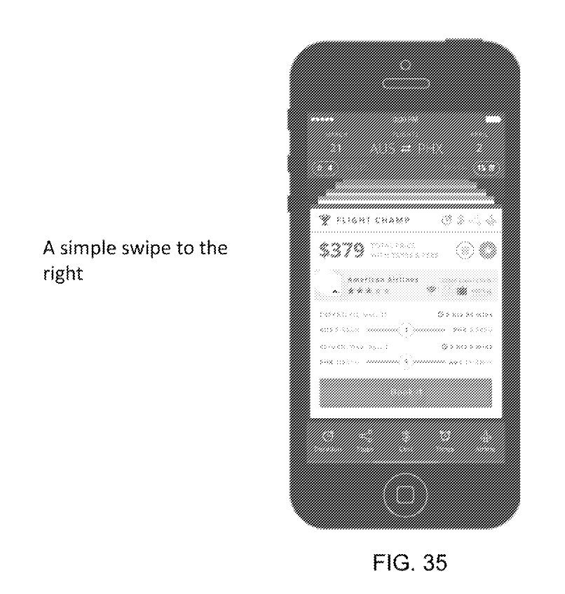

FIG. 35 shows an embodiment of a GUI for a persona-based decision assistant including a highlighted option to access the underlying persona information in order to configure particular preferences.

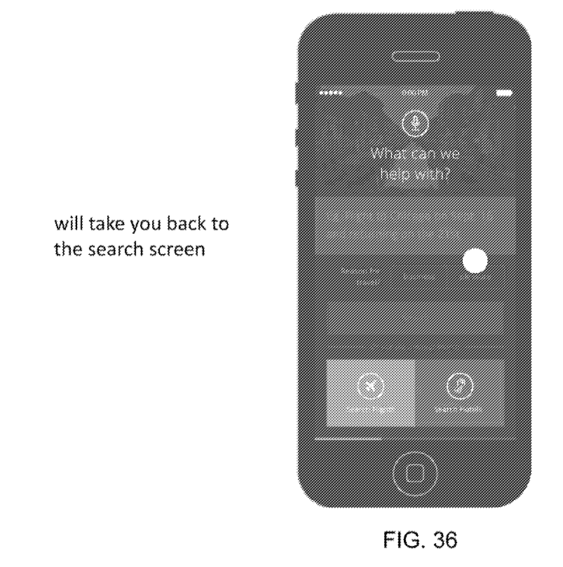

FIG. 36 shows an embodiment of a GUI for a persona-based decision assistant including options available upon selection of the highlighted option of FIG. 35. The user may adjust the reason for the trip, search flights, and even expand the travel search to other related searches, such as hotels, car rentals, entertainment, and so on.

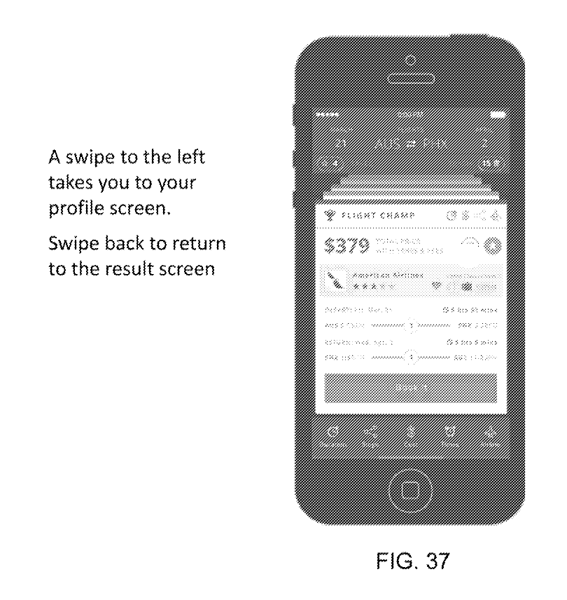

FIG. 37 shows an embodiment of a GUI for a persona-based decision assistant that shows the GUI presenting the travel card. As the user swipes in one direction, the GUI returns to the travel card. Swiping in the other direction causes the GUI to present a profile screen for adjusting preferences.

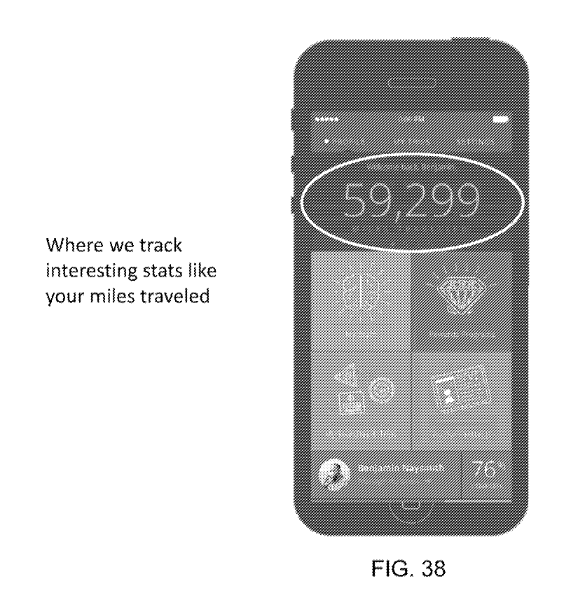

FIG. 38 shows an embodiment of a GUI for a persona-based decision assistant including a profile screen. The profile screen may present statistics, such as the number of miles traveled. The profile screen also gives the user access to rewards programs, account settings, past searches and trips, and the “My Brain” screen.

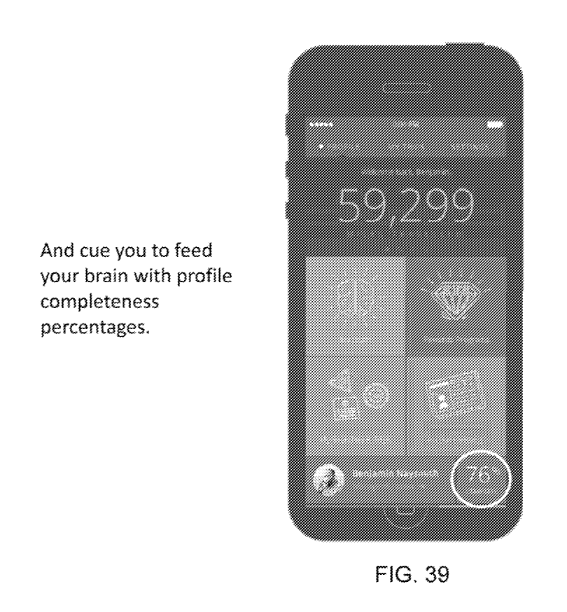

FIG. 39 shows an embodiment of a GUI for a persona-based decision assistant including the profile screen of FIG. 38. The GUI further includes a highlighted portion that includes a cue indicating a percentage of completeness of the user's profile. The Brain of the persona operates on the profile information to assist in weighing and presenting search results and in anticipating the user's needs.

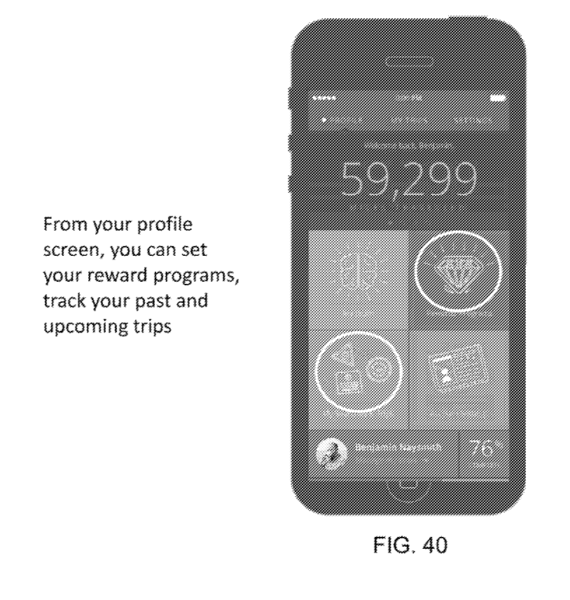

FIG. 40 shows an embodiment of a GUI for a persona-based decision assistant including the profile screen of FIG. 38. The GUI further includes highlighted areas including the my searches and trips option and the rewards program option. Accessing the rewards program option allows a user to configure reward program settings, such as airline reward programs, etc. The my searches and trips option can allow a user to review, rename, repeat or hide past trips. The my searches and trips option may also allow a user to view, track, or rename upcoming trips, and may also allow a user to view or re-fresh results on recent searches.

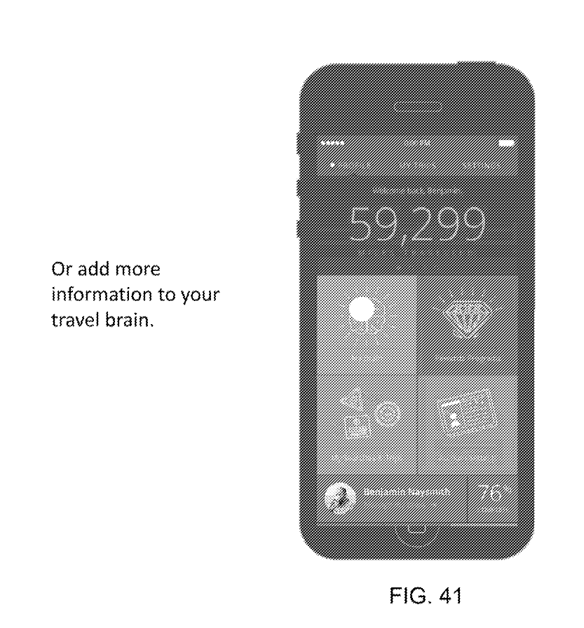

FIG. 41 shows an embodiment of a GUI for a persona-based decision assistant including the My Brain option, which is accessible by a user to add more information to the “travel brain” of the persona. Accessing the My Brain option may cause the GUI to present a page of travel-related preferences for the user to configure.

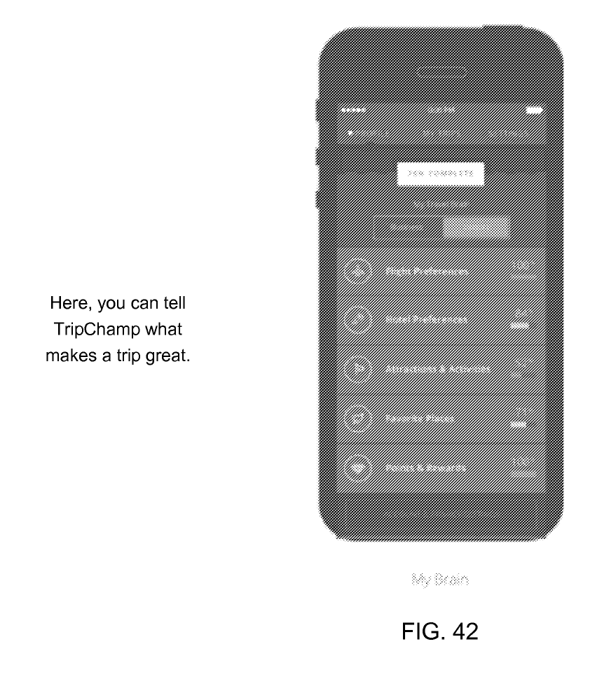

FIG. 42 shows an embodiment of a GUI for a persona-based decision assistant including the My TravelBrain page, which includes multiple selectable elements for configuring the travel preferences of the persona. By accessing selectable options such as “Flight Preferences,” “Hotel Preferences,” “Attractions & Activities,” “Favorite Places,” and “Points & Rewards,” the user may configure the persona-based decision assistant 134 to identify what makes a trip great for the particular user.

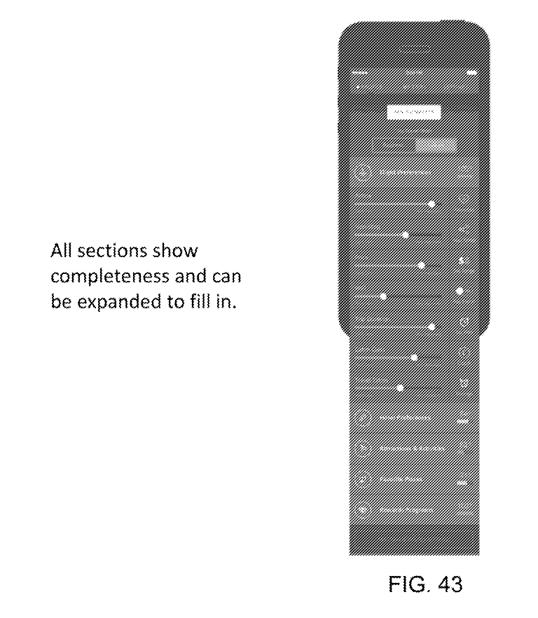

FIG. 43 shows an embodiment of a GUI for a persona-based decision assistant including an expanded view of the selected “Flight Preferences” option. Various attributes within the flight preferences may include, but are not limited to, particular airline preferences, number of connections preferences, price preferences, seat pitch preferences, wireless access preferences, trip duration preferences, cabin class preferences, and travel times preferences. In the illustrated example, the user may interact with slider bars for each preference to specify the level of importance across a range from “Don't Care” to “Very Important.” There can also be different slider bars, or any other type of input selectors, that allow a user to provide information or feedback to the AI system. For example, there may be different preference selectors for domestic travel and international travel.

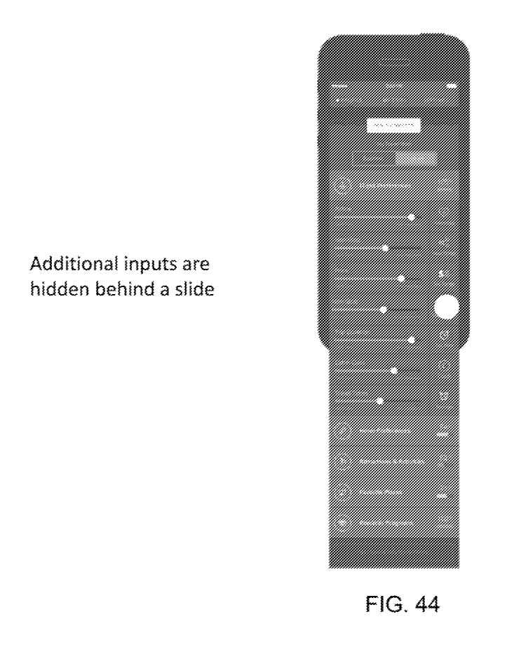

FIG. 44 shows an embodiment of a GUI for a persona-based decision assistant, which may include additional inputs accessible by clicking a selectable element adjacent to the slider bar.

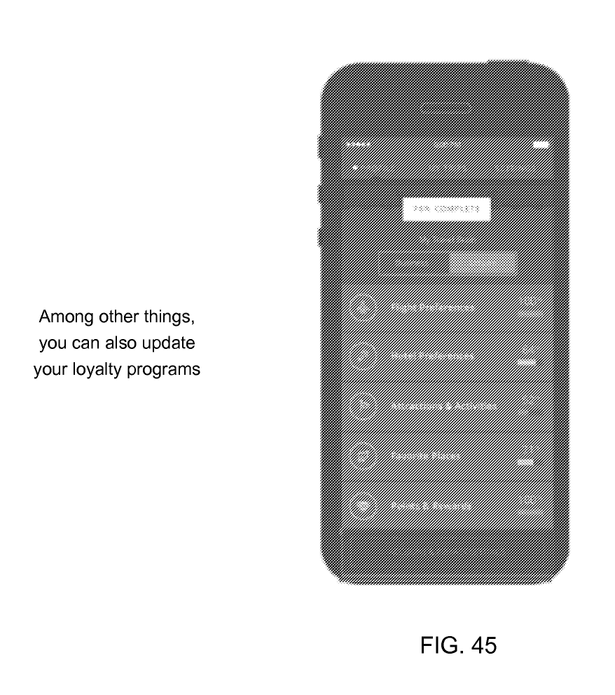

FIG. 45 shows an embodiment of a GUI for a persona-based decision assistant, which may include percentages of completeness for each of the preferences. Further, among other options, the user-selectable elements include options to update loyalty programs and to continue to add information.

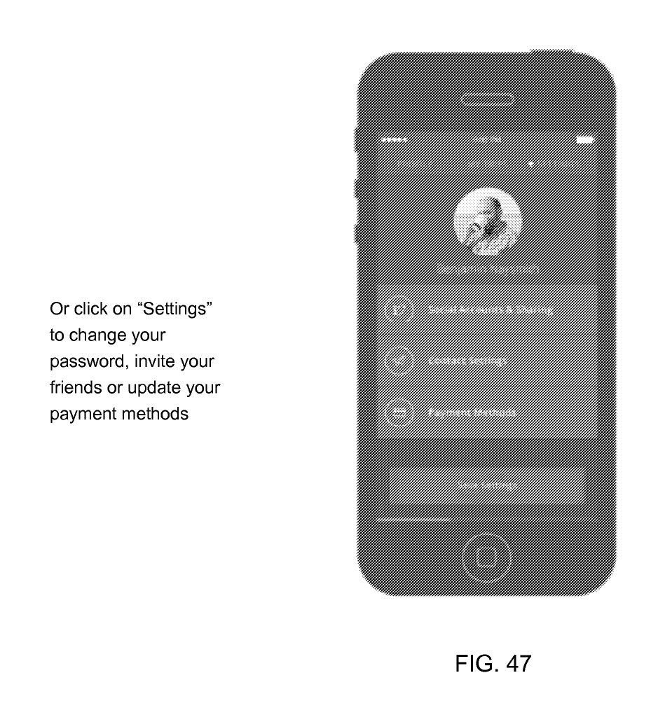

The user may select the “MY TRIPS” option from the menu bar across the top of the GUI to access previous searches, upcoming trips or past trips. This page may also be accessed, for example, by selecting the My Searches & Trips option in the GUI depicted in FIG. 41. Selection of either of the above options may cause the GUI to present a list of previous trips or searches as described below with respect to FIG. 47.

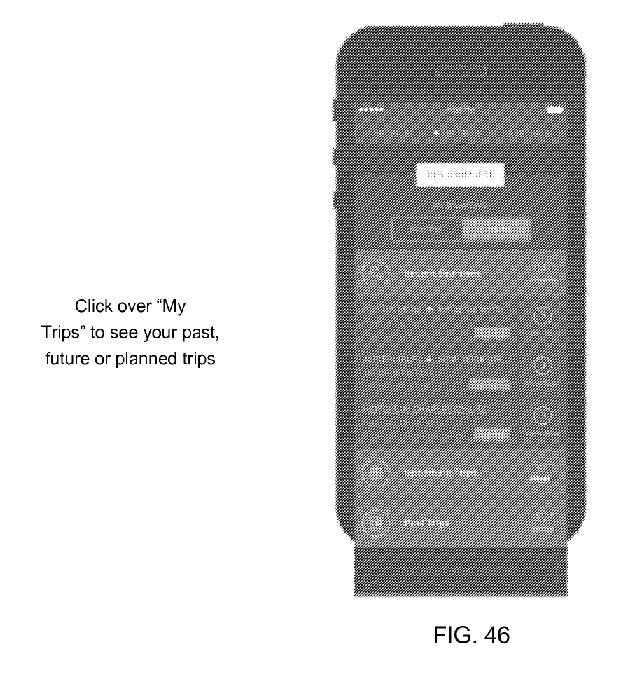

FIG. 46 shows an embodiment of a GUI for a persona-based decision assistant including an option to access recent searches, an option to access upcoming trips, and an option to access past trips. In this example, the user may select “Recent Searches” to access a list of recent searches and then to click into the search. In another example, the user may select “Past Trips” to view past trip information.

From the GUIs of FIGS. 45 and 46, the user may access the “SETTINGS” option from the menu bar across the top of the page to access settings associated with the user. One example of a Settings Page is described below with respect to FIG. 47.

FIG. 47 shows an embodiment of a GUI for a persona-based decision assistant including a Settings page through which a user may change his/her password, add or invite friends, update payment methods, share data, and the like.

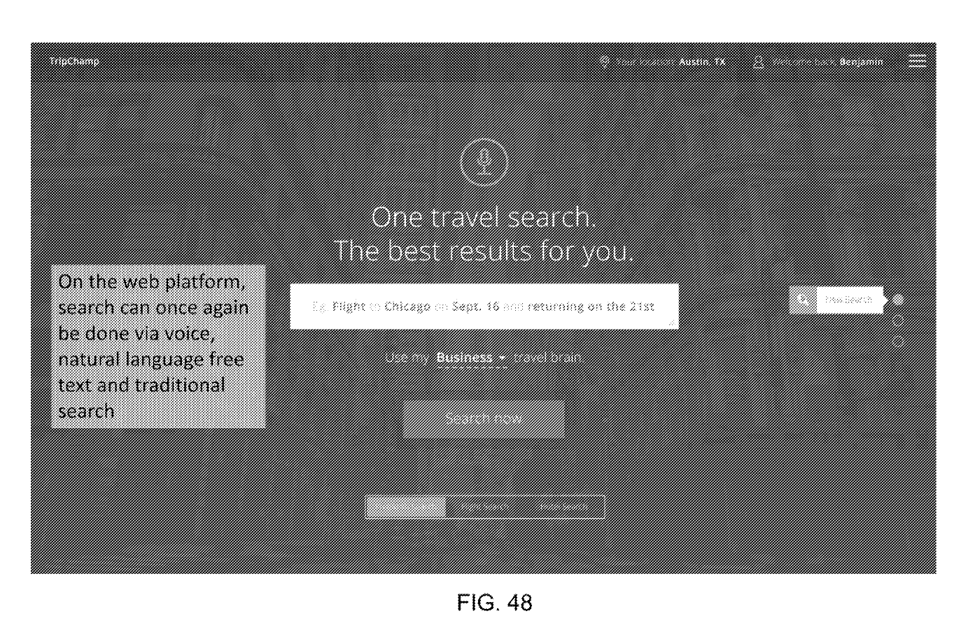

The example embodiments presented in FIGS. 2-47 were shown on a portable computing device, such as smart phone. However, it should be appreciated that the persona-based decision assistant may also be presented as a graphical user interface on another type of computing device such as via web pages within a web browser or other computer program. In certain embodiments, the computing system 102 in FIG. 1 may be a computer server. In certain embodiments, the computing system 102 may include multiple processors and distributed memory, depending on the implementation. Possible examples of a web page implementation are described below with respect to FIGS. 48-68. Such web pages and views could also be configured as a stand-alone (i.e. not needing a web browser) software program executable by a computing device, such as described herein.

FIG. 48 shows an embodiment of a screen view, such as via a web page or other computer program, for a persona-based decision assistant including user-selectable options. The web page allows the user to specify a business travel sub-persona (which might also be referred to as a brain), or another travel sub-persona through a pull-down menu. Further, the web page includes an input field that allows the user to provide input and includes selectable options to specify the type of search, such as a freeform search, a flight search, and a hotel search.

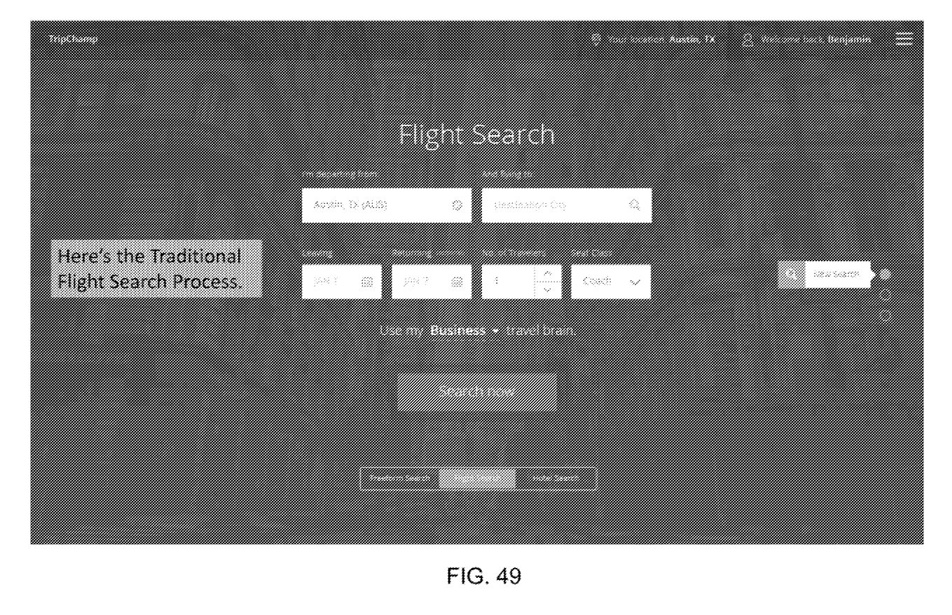

FIG. 49 shows an embodiment of a screen view, such as via a web page or other computer program, for a persona-based decision assistant including options for a flight search when the Flight Search option is selected.

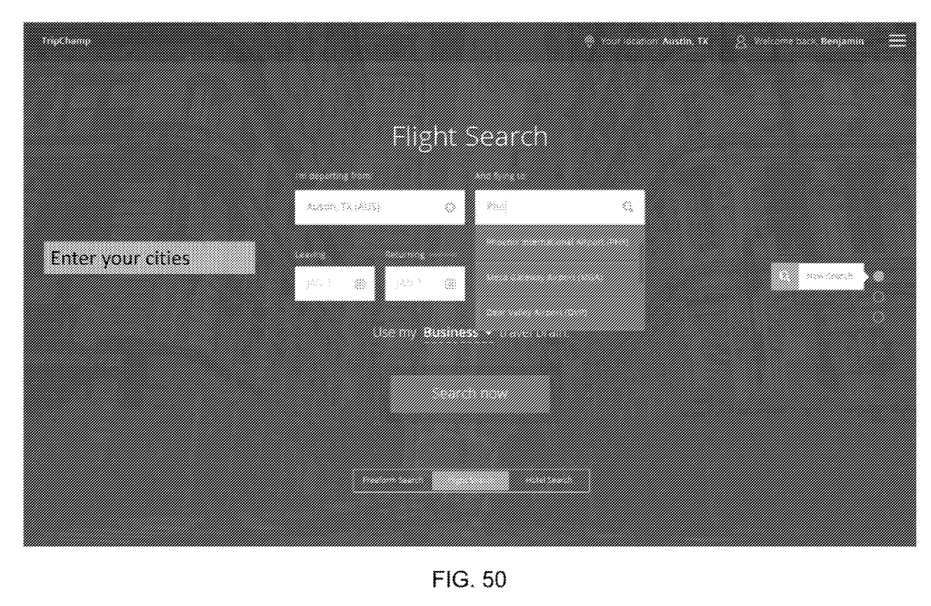

FIG. 50 shows an embodiment of a screen view, such as via a web page or other computer program, for a persona-based decision assistant including an intelligent assistant for the airport data entry. In the illustrated example, as the user begins typing “Phoenix,” the GUI presents selectable option corresponding to area airports so that the user can identify the specific airport.

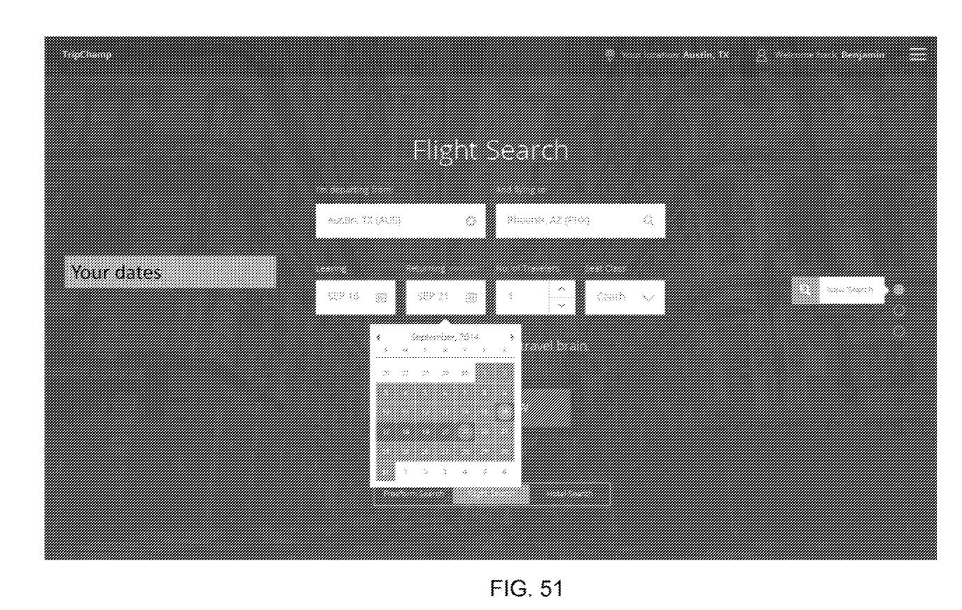

FIG. 51 shows an embodiment of a screen view, such as via a web page or other computer program, for a persona-based decision assistant including date fields that, when accessed, cause the GUI to provide a calendar to allow the user to select departure and return dates, the number of travelers, and the seat class (i.e., Coach class, or other).

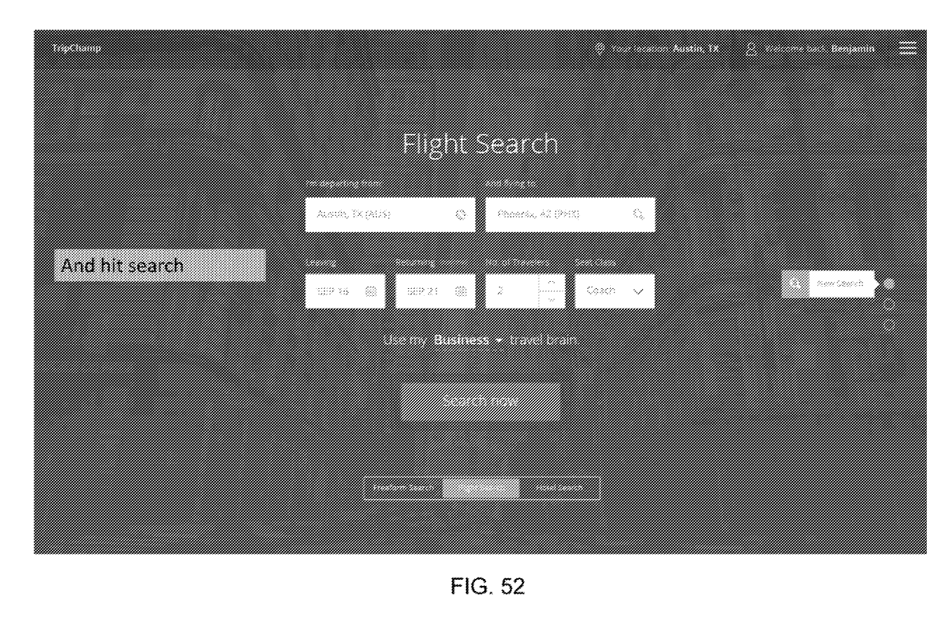

FIG. 52 shows an embodiment of a screen view, such as via a web page or other computer program, for a persona-based decision assistant including selection of the “Search Now” button after configuring the flight information.

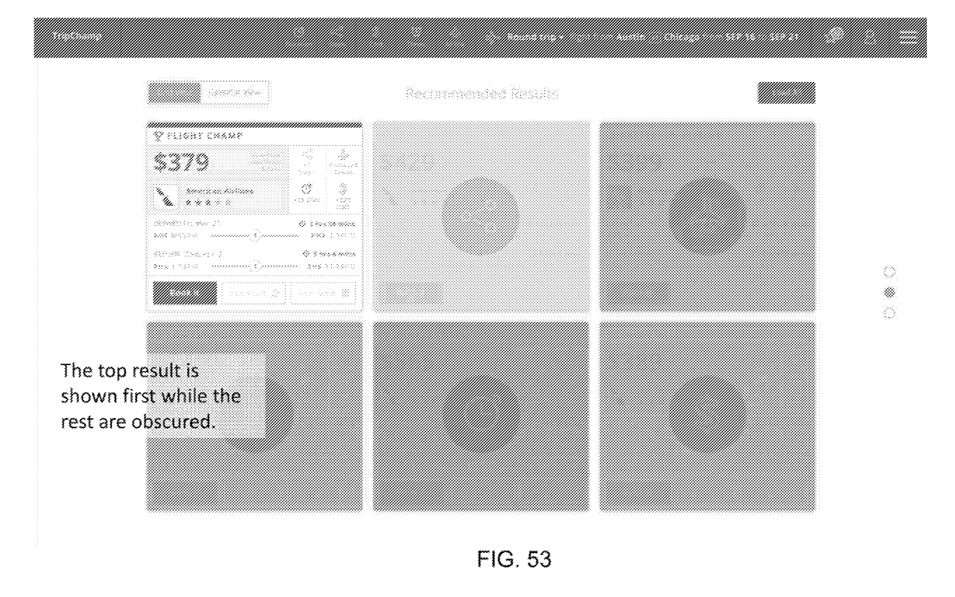

FIG. 53 shows an embodiment of a screen view, such as via a web page or other computer program, for a persona-based decision assistant including search results, where each search result is presented as a separate travel card. In certain embodiments, the top result according to the persona of the user is presented first, while other travel cards are partially obscured. The web page includes the option for the user to view the results in a grid or calendar view. A map view of results may also be presented.

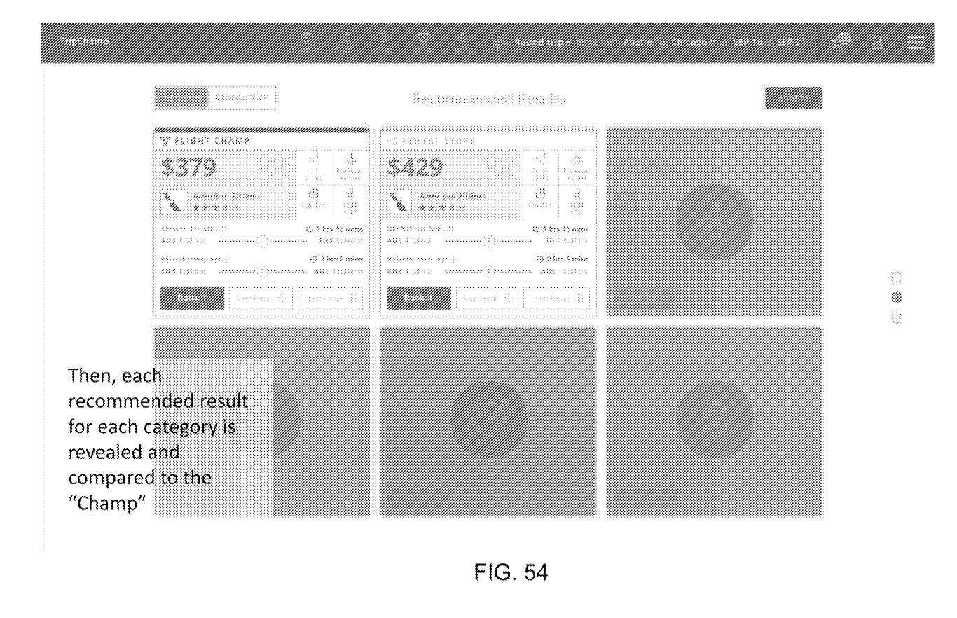

FIG. 54 shows an embodiment of a screen view, such as via a web page or other computer program, for a persona-based decision assistant including the search results with the next search result revealed (“Fewest Stops”). The web page may reveal each recommended result for each category (i.e., cost, number of connections, duration, airline, etc.), and the results may be compared.

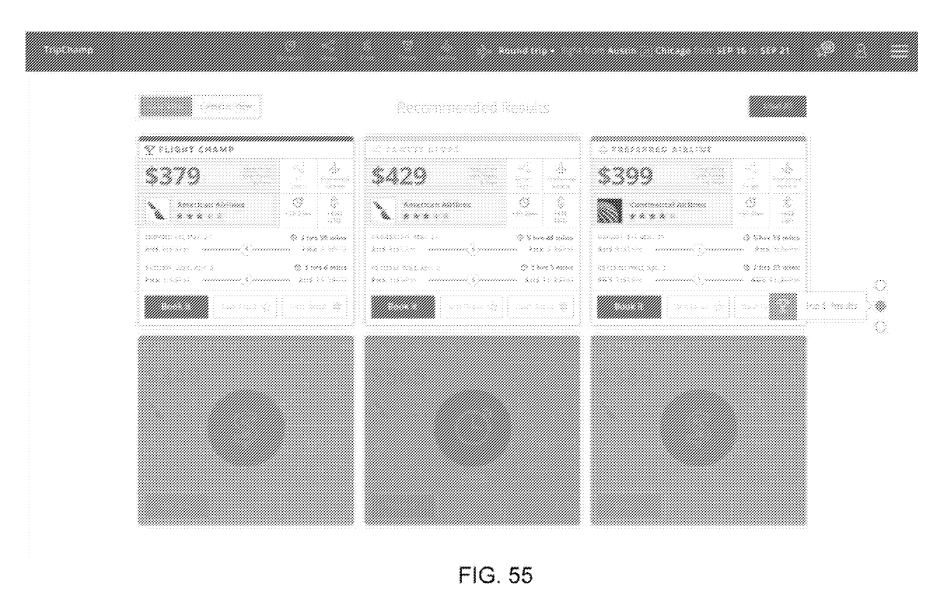

FIG. 55 shows an embodiment of a screen view, such as via a web page or other computer program, for a persona-based decision assistant including the search results with a third search result revealed (“Preferred Airline”). The web page may further include an option for the user to specify the number of the search results that the user wants to view at one time (here, the “top 6 results” are selected).

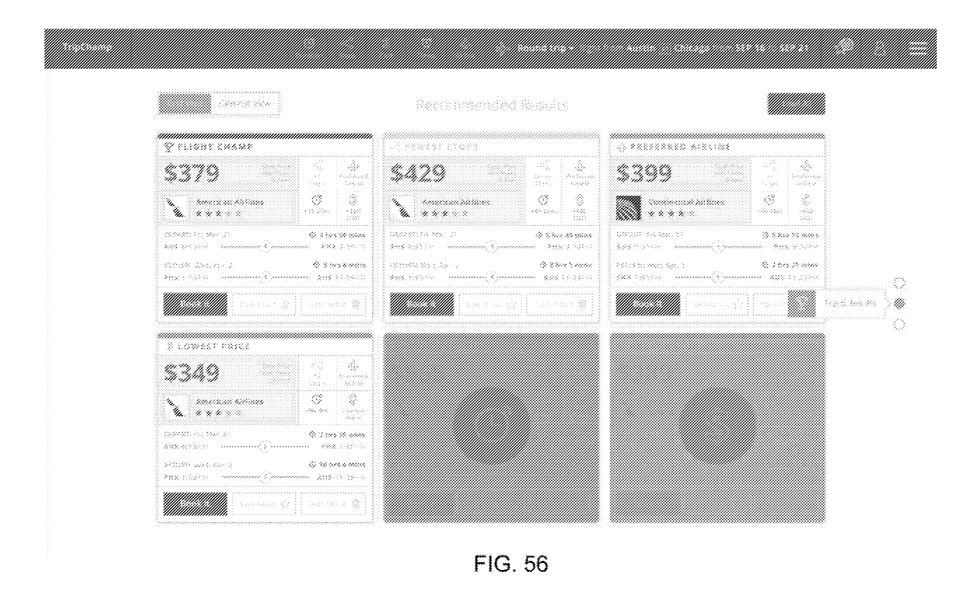

FIG. 56 shows an embodiment of a screen view, such as via a web page or other computer program, for a persona-based decision assistant including the search results with a fourth search result revealed (“Lowest Price”).

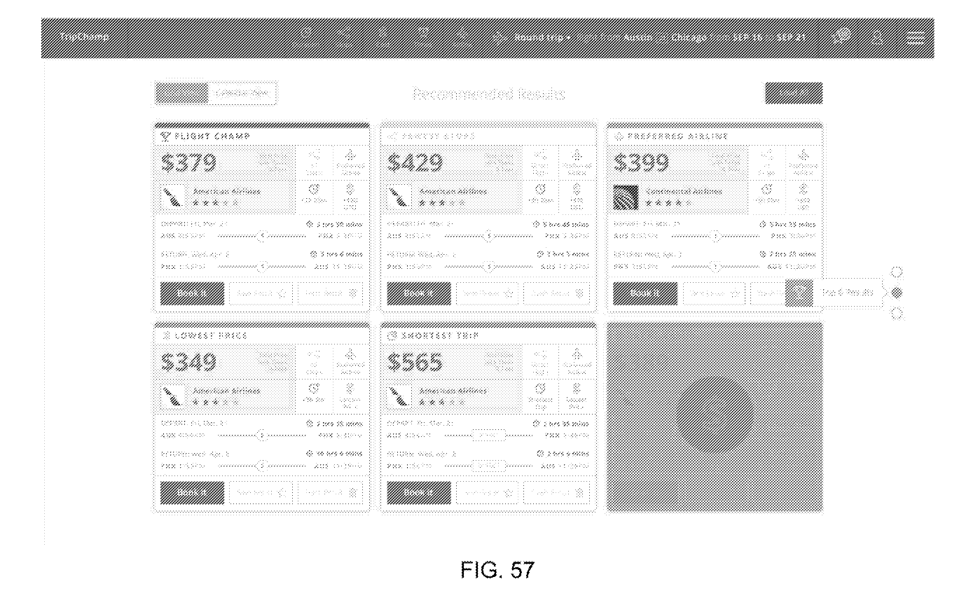

FIG. 57 shows an embodiment of a screen view, such as via a web page or other computer program, for a persona-based decision assistant including the search results with a fifth search result revealed (“Shortest Trip”).

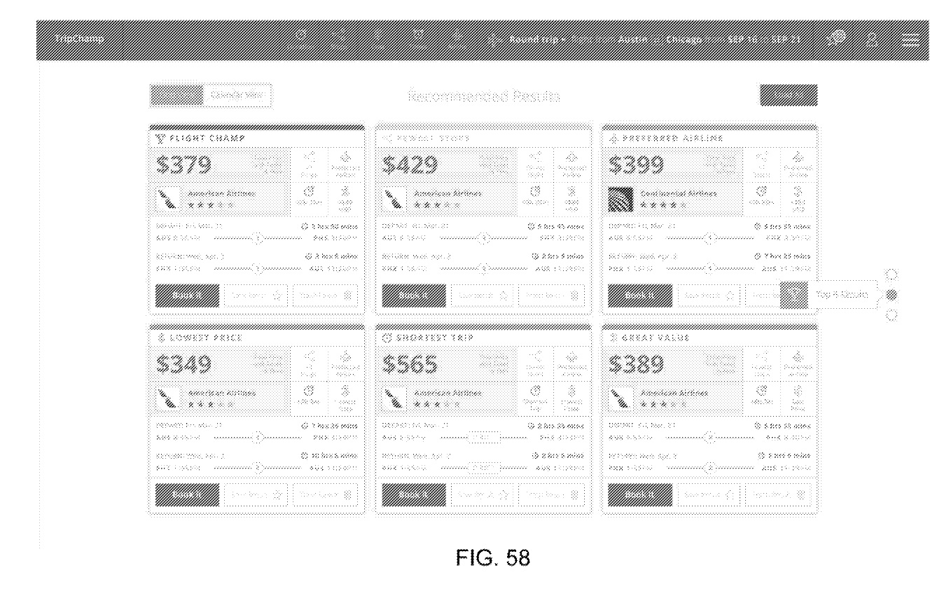

FIG. 58 shows an embodiment of a screen view, such as via a web page or other computer program, for a persona-based decision assistant including the search results with a sixth search result revealed (“Great Value”). However, the system can prioritize based on any factors and use any description for any product, the system doesn't need to be these factors and these titles are just illustrative.

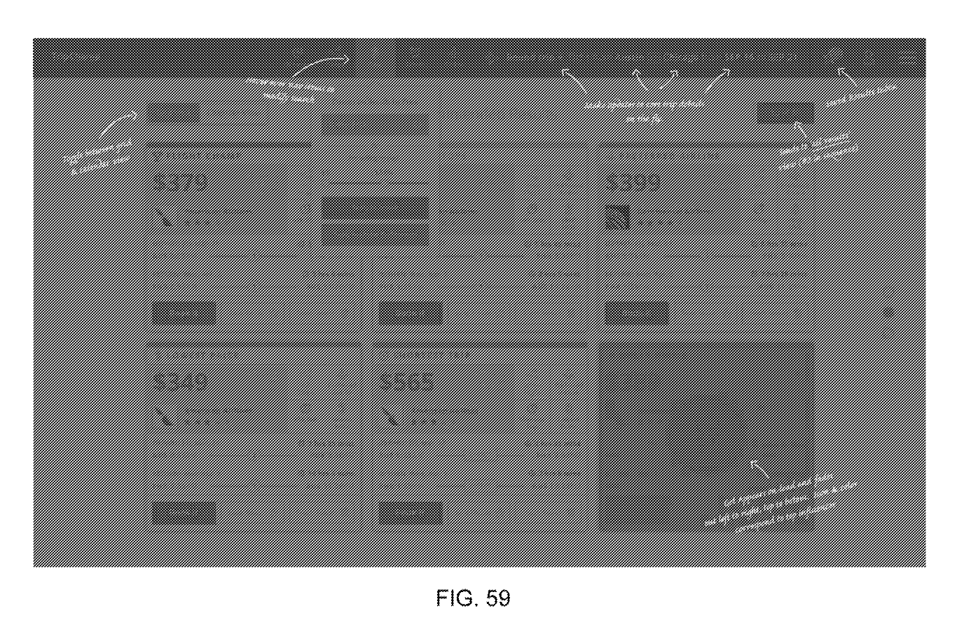

FIG. 59 shows an embodiment of a screen view, such as via a web page or other computer program, for a persona-based decision assistant including other user selectable options. In an example, the user may toggle between the grid and calendar view. The user may also have an option to view a map view, which may pinpoint results or highlight an area with results. The user may hover over icons, such as the clock, the number of stops, the cost, the duration, and the airline to modify search criteria. The web page may also include trip details that can be accessed from the title bar at the top of the page to update core trip details. The web page further includes a saved results inbox. The web page also includes an option to view all results.

In certain embodiments, the search results may be uncovered within the GUI, one at a time, from left-to-right and top down. In certain embodiments, the search results may be uncovered in a different order. In certain embodiments, the user may select which results are to be uncovered while the unselected results are not uncovered.

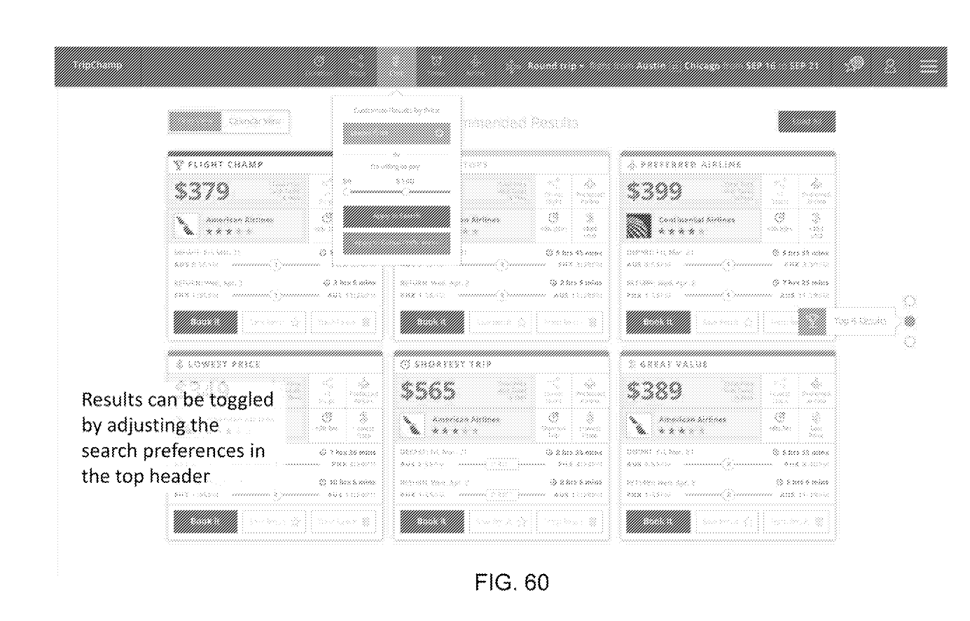

FIG. 60 shows an embodiment of a screen view, such as via a web page or other computer program, for a persona-based decision assistant including the search results, and the user may select the cost option from the menu bar, which causes the page to display cost settings for the persona.

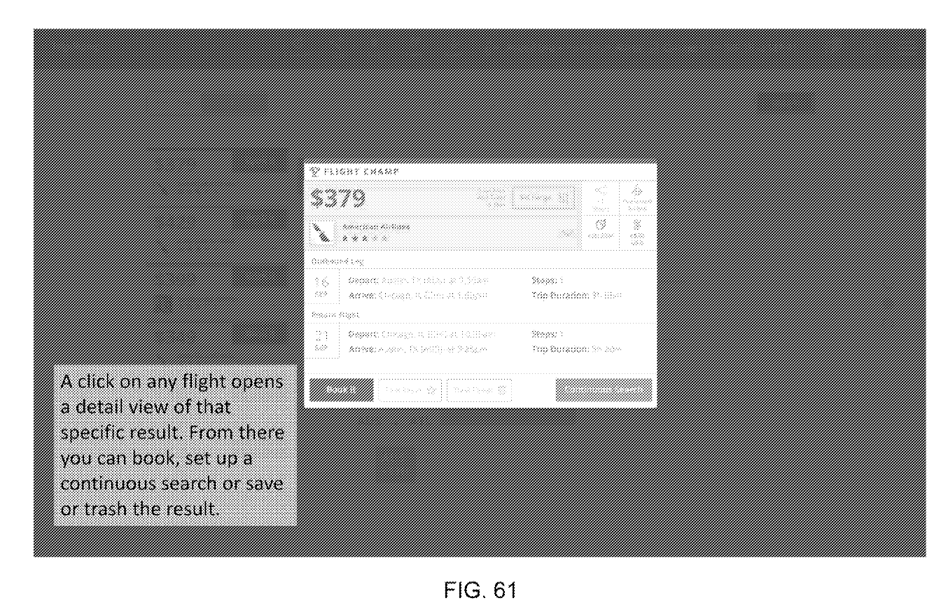

FIG. 61 shows an embodiment of a screen view, such as via a web page or other computer program, for a persona-based decision assistant including a travel card selected by the user. Once the travel card is displayed, clicking on any flight opens a detailed view of that specific result. From the travel card, the user may set up a continuous search to search for better priced or better timed options, or for any other better factor or factors the user chooses or for a result the system thinks is better, and can book the flight.

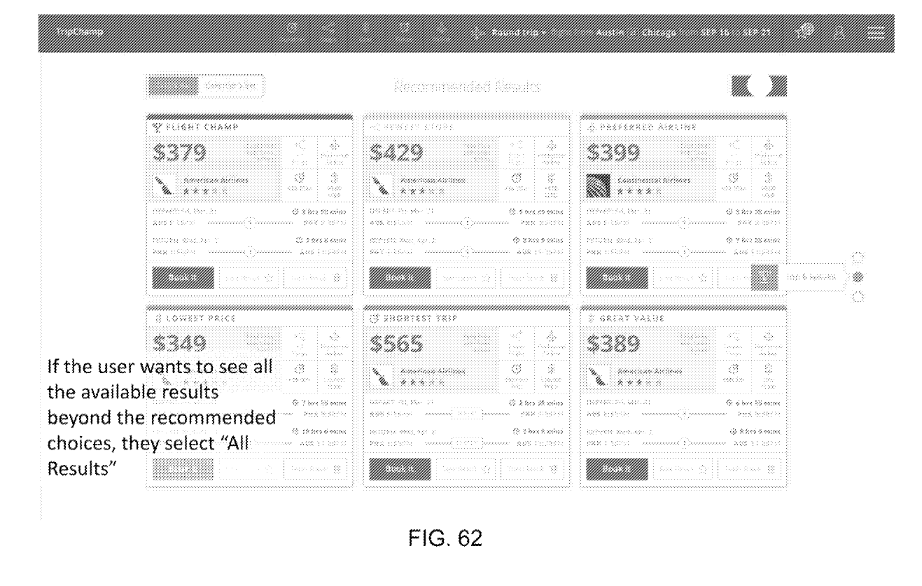

FIG. 62 shows an embodiment of a screen view, such as via a web page or other computer program, for a persona-based decision assistant including a travel card selected by the user. The web page may include a selectable element to allow the page to show all the results on the page. For example, there may be a selectable element to show the top results, as in the example shown, the top 6 results. There may also be a selectable element to show available results beyond the recommended choices. The available results may be all the possible results, or could be less than all the results but more than the top results.

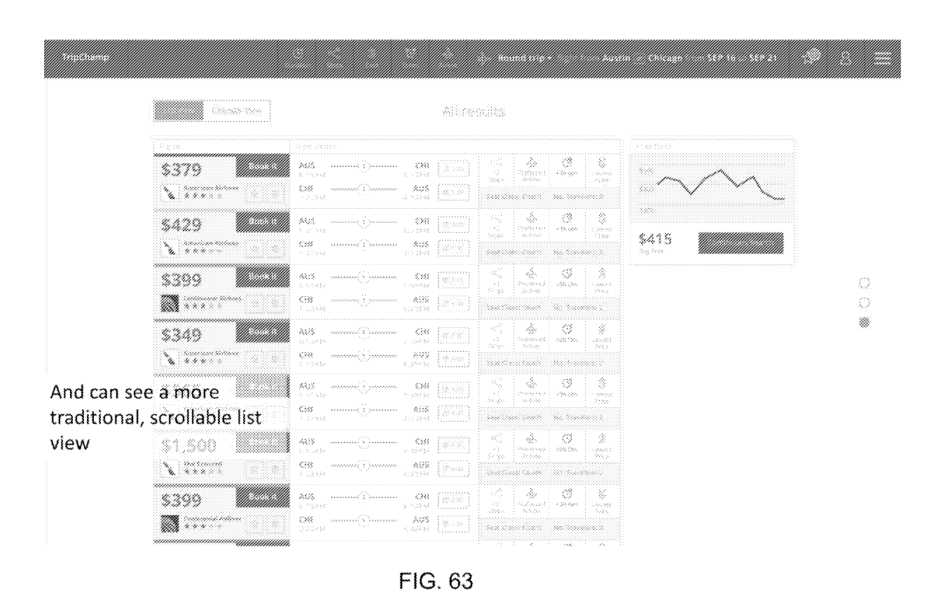

FIG. 63 shows an embodiment of a screen view, such as via a web page or other computer program, for a persona-based decision assistant including a selectable option to toggle between a list view and a calendar view. An option to view a map view may also be presented. The list view may show the top results, all the results, or any number of results in-between.

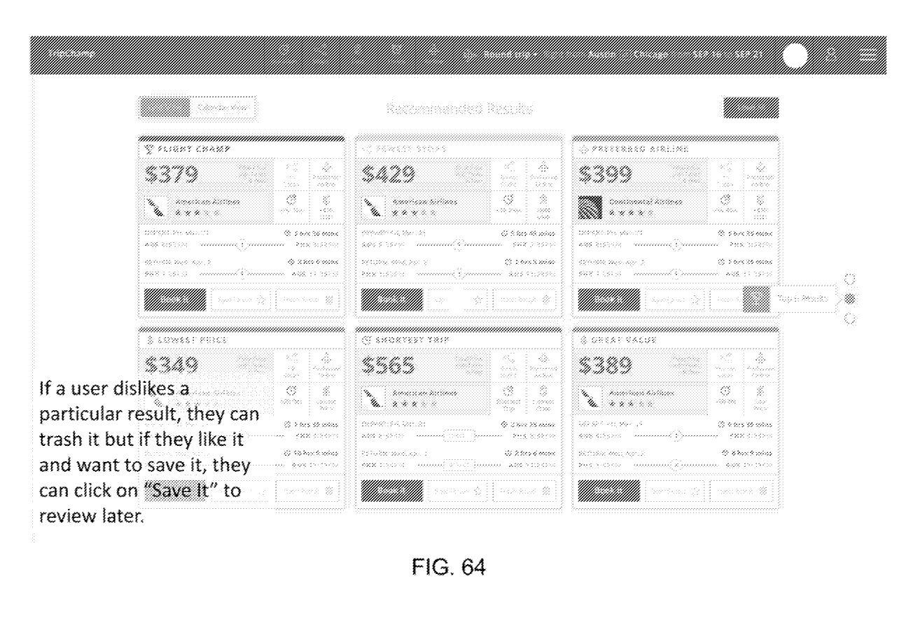

FIG. 64 shows an embodiment of a screen view, such as via a web page or other computer program, for a persona-based decision assistant including a selectable option to save a particular result. The result may be saved in a personal inventory list that a user can access and review later. The web page may also include a selectable trash or delete option, which would remove the result from being displayed. A persona may also be updated when a result is saved or deleted to learn preferences by which the user saves or deletes results. FIG. 65 shows an embodiment of a screen view, such as via a web page or other computer program, for a persona-based decision assistant including a list view that may show saved results.

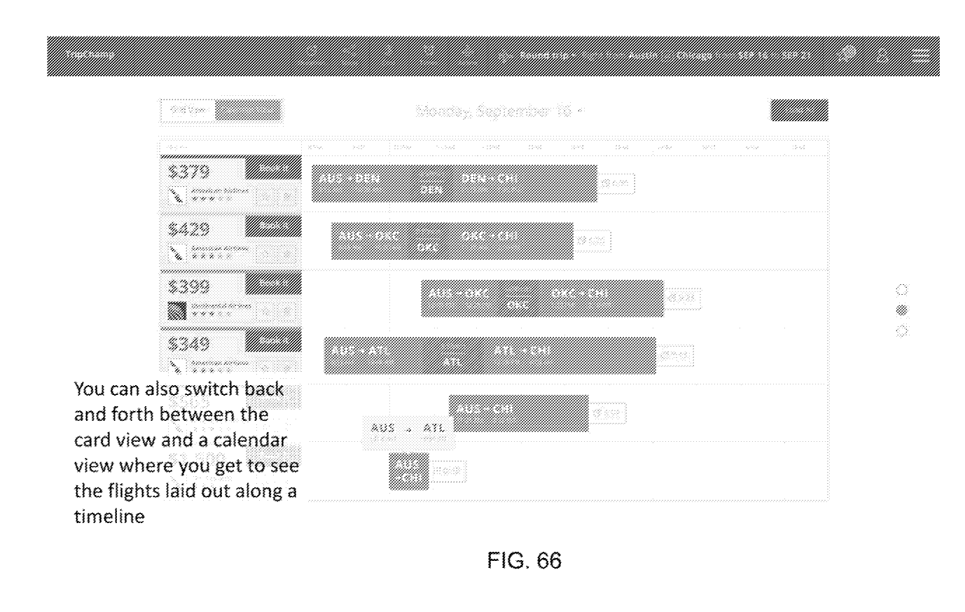

FIG. 66 shows an embodiment of a screen view, such as via a web page or other computer program, for a persona-based decision assistant including a selectable option to toggle between the grid view (of FIG. 53-60) and a calendar view. An option to view a map view can also be provided. In response to user selection of the calendar view option, the web page displays the results in a calendar format.

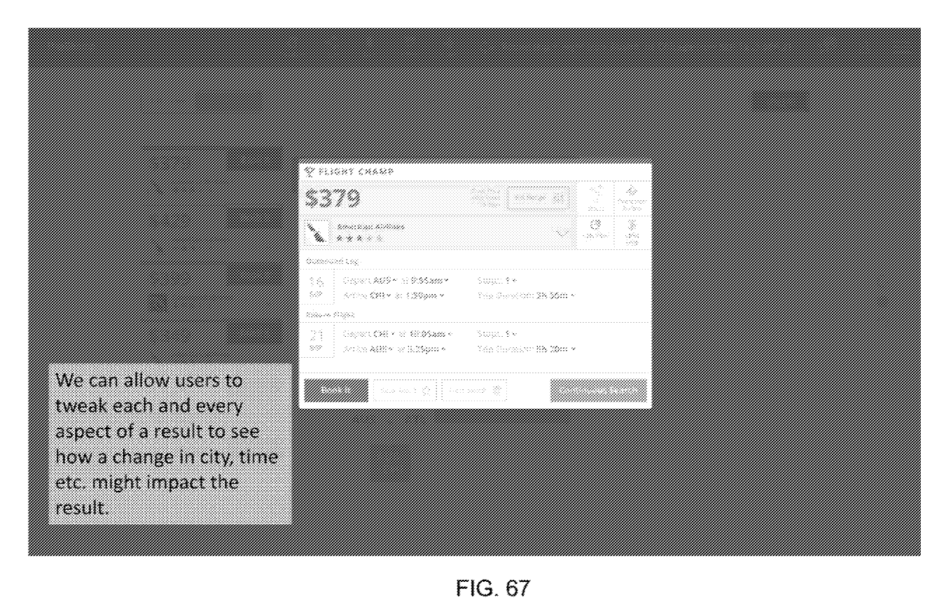

FIG. 67 shows an embodiment of a screen view, such as via a web page or other computer program, for a persona-based decision assistant including a selected travel card. The user may access each element of the travel card to tweak each and every aspect, and multiple aspects, of the search result to see how a change in city, time, date, airline etc. might impact the result.

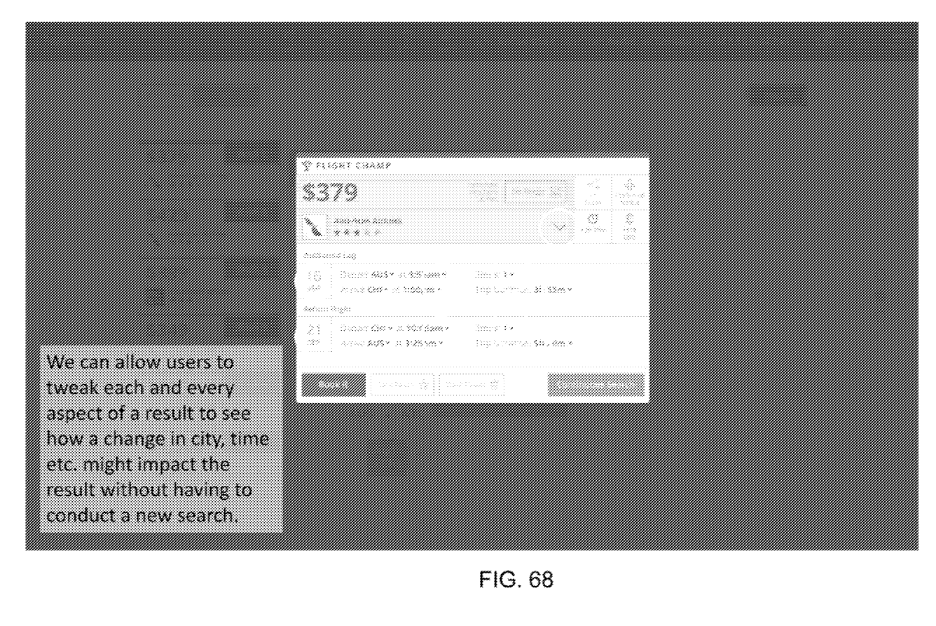

FIG. 68 shows an embodiment of a screen view, such as via a web page or other computer program, for a persona-based decision assistant including some of the user-selectable elements within the travel card, which may be accessed to adjust the result. Once again, the travel card includes a book it option, the choice to hold the fare for a fee, as well as a continuous search notification. That is, the continuous search occurs in the background to update in real-time the selected preferred result onto the card. The circled elements are some examples of user selectable weighing options, filters, or inputs that can be incorporated into the continuous searching and may update or change the search result shown on this specific card in real-time as a different search result is selected and displayed. Even further, in some examples, while the continuous search is occurring, a result on the selected card could be updated with a new search result without any user interaction (e.g. the user does not select any options or change any views) as the search results find better preferred decision options in real-time.

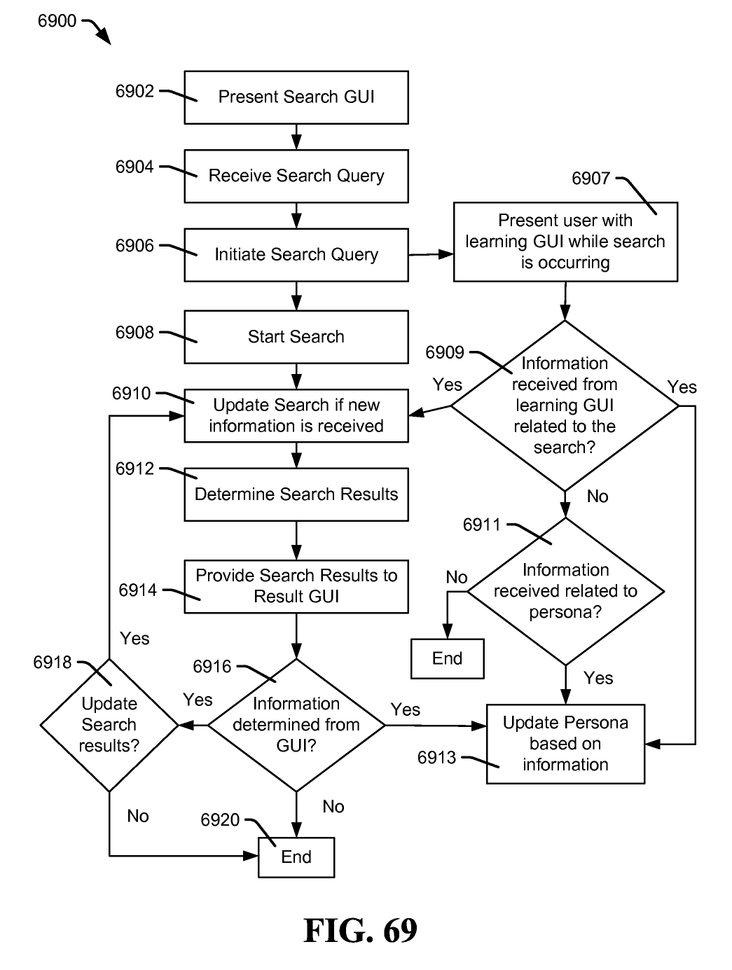

Referring to FIG. 69, a flowchart of a method of a learning decision system search query is shown and generally designated 6900. A search GUI may be presented to a user to allow the user to search one or more databases or information sets, at 6902. The search GUI may be any type of search, and in some examples may be a travel search such as for hotel rooms or airline tickets. Search GUI can receive a user via user inputs, such as text, voice, or gestures, at 6904. The user can then initiate the search query, at 6906, such as by submitting or sending the search criteria from an end user computing device to a client, which may be done through a customized application or website. Once the search query has been submitted, the server or searching computer may start searching based on the provided query, at 6908.

While the search is occurring at the server, a learning GUI may be presented to the user in a substantially parallel time frame as the search is occurring, at 6907. The learning GUI can present further questions or options to the user to answer, such as shown in FIG. 3 for example. The questions or options may directly relate to the pending search or may be completely unrelated. The learning GUI may be presented and may collect the additional information after starting the search but before any indication of a result is provided to the user or the search result GUI. A determination may be made whether additional information received pertains to the pending, in-progress search, at 6909. When information is received that relates to the in-progress search, such information may be provided to the search query interface (such as via an Application Programming Interface, which all search settings may be configured to communicate via) and the in-progress search may be updated or changed based on the information, at 6910, which can occur before any indication of a result is provided to a search result GUI. Then, the search results can be determined based on a combination of the original submitted query and the additional new information, at 6912. Thus, in some instances, the user may be presented with only one set of search results (the set could be one or more results), at 6914, even though the search results have been further refined or filtered based on the new information gained after the original search query was submitted. Once the search results are presented to the user via the search result GUI, such as shown in FIGS. 4-5 and 19-23 as well as many other examples provided herein, the user may choose to select a search result, manipulate a search result, delete a search result, research a search result, further refine a search, or interact with the search result(s) in any other way the search result GUI allows. In addition, the system(s) may continuously search for or determine better desired outcomes (e.g. better priced or schedule travel results) even after an outcome/result has been presented to a user.

The user's interaction with the search result GUI, the search submission GUI, or both may be tracked by the local computer program providing the GUI, the server, or both. A determination may be made whether such information is received, at 6916. When further information is received after the search result is provided, the method 6900 may determine whether to update the search results, at 6918, though in some embodiments this may be done automatically when further information is received after the search result is provided. The further information can be submitted back to the query server and combined with the original query information (from step 6904) and the new information (from step 6907) to provide yet a different search result, at 6910. In some embodiments, the new information (from step 6907), the additional information (from step 6916), or both may be submitted to update a persona in a decision learning search system, at 6913. In some instances, the persona may correspond to the specific user or may be a group persona or may be another type of persona. In some instances, information may be collected from the user that does not pertain to the search but may still update the persona, at 6911. Once the user provides no more information to the search GUI, result GUI, or the learning GUI, the method 6900 may end at 6920. Further, any of the information received via a GUI can be fed into a continuous search system such that a continuous background search is receiving the new information or the additional information independent of whether the user initiates the sending or initiates the continuous search.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A system comprising:
a processor; and
a memory accessible to the processor and storing instructions that, when executed, cause the processor to:
provide, via a graphical user interface, a selected one of a plurality of decision options; and
obscure others of the plurality of decision options.

2. The system of claim 1, wherein the memory further comprises instructions that, when executed, cause the processor to selectively reveal others of the plurality of decision options.

3. A system comprising:
a processor; and
a memory accessible to the processor and storing instructions that, when executed, cause the processor to:
provide, via a graphical user interface (GUI), a plurality of decision options as a set of cards, each card representing a decision option of the plurality of decision options; and
selectively alter an appearance of the card within the graphical user interface in response to an input.

4. The system of claim 3, wherein an appearance of the card is selectively altered, within the GUI, by providing a view that represents a back side of the card.

5. The system of claim 3, wherein the memory further includes instructions that, when executed cause the processor to:
move the image of the card within the GUI in response to the input;
store a decision option associated with the card when the card is moved in a first direction; and
discard a decision option associated with the card when the card is moved in a second direction.

6. A system comprising:
a processor; and
a memory accessible to the processor and storing instructions that, when executed, cause the processor to:
receive decision options corresponding to a plurality of possible options;
provide, via a graphical user interface, a selected one of the plurality of possible options; and
obscure others of the plurality of itineraries.

7. The system of claim 6, wherein the memory further includes instructions that, when executed, cause the processor to:
include one or more user-selectable elements within the graphical user interface;
receive input corresponding to one of the user-selectable elements; and
provide one or more options to configure a continuous decision making process related to a selected decision option.
